(19) United States
(12) Patent Application Publication
(10) Pub. No.: US 2026/0018792 A1
(43) Pub. Date: Jan. 15, 2026

(54) ELECTRONIC DEVICE INCLUDING ANTENNA STRUCTURE USING INNER STRUCTURE

(71) Applicant: Samsung Electronics Co., Ltd., Suwon-si (KR)

(72) Inventors: Byungman LIM, Suwon-si (KR); Donghun PARK, Suwon-si (KR); Jaewoong JEON, Suwon-si (KR); Gyubok PARK, Suwon-si (KR); Youngjun CHO, Suwon-si (KR); Seonho LIM, Suwon-si (KR); Junggil KIM, Suwon-si (KR); Woosik CHO, Suwon-si (KR)

(21) Appl. No.: 19/264,293

(22) Filed: Jul. 9, 2025

Related U.S. Application Data
(63) Continuation of application No. PCT/KR2025/009886, filed on Jul. 8, 2025.

(30) Foreign Application Priority Data
Jul. 11, 2024 (KR) 10-2024-0091609
Aug. 8, 2024 (KR) 10-2024-0106038
Oct. 11, 2024 (KR) 10-2024-0138611
Dec. 31, 2024 (KR) 10-2024-0201837

(51) Int. Cl. H01Q 5/328; H01Q 1/24

(52) U.S. Cl. CPC H01Q 5/328; H01Q 1/243

(57) ABSTRACT

An electronic device is provided. The electronic device includes a housing including a front plate and a rear plate disposed opposite to the front plate, a support plate disposed in a space between the front plate and the rear plate and including a first opening provided to penetrate the support plate, a second opening provided to penetrate the support plate at a position adjacent to the first opening and aligned with the first opening along a first direction, a first dividing portion and a second dividing portion extending in an area between the first opening and the second opening, and an insulating portion configured to mechanically connect the first dividing portion and the second dividing portion but electrically insulate the first dividing portion and the second dividing portion, and a printed circuit board disposed on the support plate and electrically connected to the support plate in an area between the first opening and the second opening, wherein at least a portion of the support plate around the first opening or the second opening is configured to function as an antenna and to perform wireless communication in a first frequency band.

### CROSS-REFERENCE TO RELATED APPLICATION(S)

This application is a continuation application, claiming priority under 35 U.S.C. § 365(c), of an International application No. PCT/KR2025/009886, filed on Jul. 8, 2025, which is based on and claims the benefit of a Korean patent application number 10-2024-0091609, filed on Jul. 11, 2024, in the Korean Intellectual Property Office, of a Korean patent application number 10-2024-0106038, filed on Aug. 8, 2024, in the Korean Intellectual Property Office, of a Korean patent application number 10-2024-0138611, filed on Oct. 11, 2024, in the Korean Intellectual Property Office, and of a Korean patent application number 10-2024-0201837, filed on Dec. 31, 2024, in the Korean Intellectual Property Office, the disclosure of each of which is incorporated by reference herein in its entirety.

### TECHNICAL FIELD

The disclosure relates to an electronic device. More particularly, the disclosure relates to an electronic device including an antenna structure using an inner structure.

### BACKGROUND ART

Typically, “electronic device” may mean a device performing a particular function according to its equipped program, such as a home appliance, an electronic scheduler, a portable multimedia player, a mobile communication terminal, a tablet personal computer (PC), a video/sound device, a desktop PC or laptop computer, a navigation for automobile, etc. For example, the electronic devices may output stored information as voices or images. As electronic devices are highly integrated and high-speed, high-volume wireless communication becomes commonplace, mobile communication terminals are recently being equipped with various functions. For example, an electronic device comes with the integrated functionality, including an entertainment function, such as playing video games, a multimedia function, such as replaying music/videos, a communication and security function for mobile banking, and a scheduling or e-wallet function.

Electronic devices, such as smartphones, which are becoming smaller and more integrated with various functions, may provide a more convenient user environment by maintaining a stable communication state in a mobile environment. For example, a single electronic device may be implemented to perform commercial communications in a plurality of frequency bands and may be equipped with wireless communication capabilities of different communication protocols, such as Wi-Fi or near field communication. There is ongoing research to add other operable frequency bands, depending on the communication protocol, and an electronic device may come equipped with wireless communication functions based on additional communication protocols for millimeter-wave communication or ultra-wideband communication. By performing wireless communication in an additional frequency band or based on additional communication protocols, electronic devices may provide a more stable wireless access environment while providing enhanced communication speeds.

The above information is presented as background information only to assist with an understanding of the disclosure. No determination has been made, and no assertion is made, as to whether any of the above might be applicable as prior art with regard to the disclosure.

### DISCLOSURE OF DISCLOSURE

### Solution to Problems

Aspects of the disclosure are to address at least the above-mentioned problems and/or disadvantages and to provide at least the advantages described below. Accordingly, an aspect of the disclosure is to provide an electronic device including an antenna structure using an inner structure.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a front plate and a rear plate disposed opposite to the front plate, a support plate disposed in a space between the front plate and the rear plate and including a first opening provided to penetrate the support plate, a second opening provided to penetrate the support plate at a position adjacent to the first opening and aligned with the first opening along a first direction, a first dividing portion and a second dividing portion extending in an area between the first opening and the second opening, and an insulating portion configured to mechanically connect the first dividing portion and the second dividing portion but electrically insulate the first dividing portion and the second dividing portion, and a printed circuit board disposed on the support plate and electrically connected to the support plate in an area between the first opening and the second opening, wherein at least a portion of the support plate around the first opening or the second opening is configured to function as an antenna and to perform wireless communication in a first frequency band.

In accordance with another aspect of the disclosure, an electronic device is provided. The electronic device includes a housing including a front plate and a rear plate disposed opposite to the front plate, a support plate disposed in a space between the front plate and the rear plate, a first opening provided to penetrate the support plate, a second opening provided to penetrate the support plate at a position adjacent to the first opening and aligned with the first opening along a first direction, a printed circuit board disposed on the support plate and electrically connected to the support plate in an area between the first opening and the second opening, at least one processor, and memory storing instructions, wherein the instructions, when executed by the at least one processor individually or collectively, cause the electronic device to perform wireless communication in a first frequency band using at least a portion of the support plate around the first opening or the second opening.

In accordance with another aspect of the disclosure, an electronic device is provided. The electronic device includes a housing including a front plate and a rear plate disposed opposite to the front plate, a first supporting member disposed in a space between the front plate and the rear plate and including a coupling boss provided on one surface thereof, a first opening provided to penetrate the first supporting member at a position adjacent to the coupling boss, a second opening provided to penetrate the first supporting member at a position adjacent to, at least, the first opening of the coupling boss and the first opening and aligned with the first opening along a first direction, a printed circuit board supported on the coupling boss, disposed on the first supporting member, and electrically connected to the first supporting member through the coupling boss, at least one processor, and memory storing instructions. In an embodiment, the instructions may, when executed by the at least one processor individually or collectively, cause the electronic device to perform wireless communication in a first frequency band using at least a portion of the first supporting member around the first opening or the second opening.

In accordance with another aspect of the disclosure, an electronic device is provided. The electronic device includes a housing including a front plate and a rear plate disposed opposite to the front plate, a first supporting member disposed in a space between the front plate and the rear plate and including a coupling boss provided on one surface thereof, a first opening provided to penetrate the first supporting member at a position adjacent to the coupling boss, a second opening provided to penetrate the first supporting member at a position adjacent to, at least, the first opening of the coupling boss and the first opening and aligned with the first opening along a first direction, a printed circuit board supported on the coupling boss, disposed on the first supporting member, and electrically connected to the first supporting member through the coupling boss, a side structure configured to at least partially surround a space between the front plate and the rear plate, a radiating conductor being a portion of the side structure and electrically insulated from another portion of the side structure, and a flange protruding from an inner surface of the radiating conductor and electrically connected to the printed circuit board. In an embodiment, it may be configured to perform wireless communication in a first frequency band using at least a portion of the first supporting member and perform wireless communication in a second frequency band using the radiating conductor, around the first opening or the second opening.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a front perspective view illustrating an electronic device according to an embodiment of the disclosure;

FIG. 3 is a perspective view illustrating a rear surface of the electronic device of FIG. 2 according to an embodiment of the disclosure;

FIG. 4 is an exploded front perspective view illustrating an electronic device according to an embodiment of the disclosure;

FIG. 5 is a rear exploded perspective view illustrating an electronic device according to an embodiment of the disclosure;

FIG. 6 is a view taken along line A-A′ of FIG. 2 in an electronic device according to an embodiment of the disclosure;

FIG. 7 is a view illustrating an example of an electrical connecting structure implemented in an electronic device according to an embodiment of the disclosure;

FIG. 8 is a view illustrating an example of an electrical connecting structure implemented in an electronic device according to an embodiment of the disclosure;

FIG. 9 is a plan view illustrating a first supporting member of an electronic device according to an embodiment of the disclosure;

FIG. 10 is an enlarged view illustrating portion E1 of FIG. 9 of a first supporting member of an electronic device according to an embodiment of the disclosure;

FIG. 11 is a view illustrating an antenna structure implemented in an electronic device according to an embodiment of the disclosure;

FIG. 12 is a view illustrating an antenna structure implemented in an electronic device according to an embodiment of the disclosure;

FIG. 13 is a view illustrating an antenna structure implemented in an electronic device according to an embodiment of the disclosure;

FIG. 14 is a view illustrating an antenna structure implemented in an electronic device according to an embodiment of the disclosure;

FIG. 15 is a view illustrating a shape or disposition of a feeding pad of an electronic device according to an embodiment of the disclosure;

FIG. 16 is a view illustrating a shape or disposition of a feeding pad of an electronic device according to an embodiment of the disclosure;

FIG. 17 is a view illustrating a shape or disposition of a feeding pad of an electronic device according to an embodiment of the disclosure;

FIG. 18 is a view illustrating a shape or disposition of a feeding pad of an electronic device according to an embodiment of the disclosure;

FIG. 19 is a view illustrating a shape or disposition of a feeding pad of an electronic device according to an embodiment of the disclosure;

FIG. 20 is an enlarged view illustrating portion E2 of FIG. 9 of a first supporting member of an electronic device according to an embodiment of the disclosure;

FIG. 21 is a view illustrating a connection state of a connecting member(s) of an electronic device according to an embodiment of the disclosure;

FIG. 22 is a view illustrating a connection state of a connecting member(s) in an electronic device taken along line B-B′ of FIG. 20, according to an embodiment of the disclosure;

FIG. 23 is a graph illustrating the performance of an antenna implemented in an electronic device according to an embodiment of the disclosure;

FIG. 24 is a view illustrating an implementation example of a connecting member(s) of an electronic device according to an embodiment of the disclosure;

FIG. 25 is a view illustrating a connection state of a connecting member(s) of an electronic device according to an embodiment of the disclosure;

FIG. 26 is a view illustrating a connection state of a connecting member(s) in an electronic device taken along line C-C′ of FIG. 24, according to an embodiment of the disclosure;

FIG. 27 is a graph illustrating the performance of an antenna implemented in an electronic device according to a feeding scheme according to an embodiment of the disclosure;

FIG. 28 is a graph illustrating the performance and operation frequency band of an antenna implemented in an electronic device according to an embodiment of the disclosure;

FIG. 29 is a view illustrating an implementation example of an antenna using a second supporting member in an electronic device according to an embodiment of the disclosure;

FIG. 30 is an enlarged view illustrating portion E2 of FIG. 9 in an electronic device according to an embodiment of the disclosure;

FIG. 31 is a view illustrating a state in which a printed circuit board and/or an electronic component is disposed on a first supporting member of an electronic device according to an embodiment of the disclosure; and

FIG. 32 is an enlarged view illustrating portion E3 of FIG. 9 of a first supporting member of an electronic device according to an embodiment of the disclosure.

Throughout the drawings, like reference numerals will be understood to refer like parts, components, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As decreasing in size and weight, electronic devices may be comfortably carried or used while on the move. Since the antenna of an electronic device may generate an electromagnetic field during operation, it may be installed in a space or position where a stable communication environment may be secured against electromagnetic interference. However, in an environment where electronic devices are becoming smaller and/or lighter and various electrical/electronic components are disposed more densely, it may be difficult to arrange antennas corresponding to different communication protocols or antennas corresponding to multiple frequency bands. For example, there may be a difficulty in securing antennas to secure additional frequency bands or antennas for wireless communications according to additional communication protocols.

An embodiment of the disclosure aim to address the foregoing issues and/or drawbacks and provide advantages described below, providing an electronic device including an antenna structure implemented using an inner structure such as a supporting member.

An embodiment of the disclosure may provide an electronic device including an antenna structure capable of securing a resonant frequency in an additional frequency band.

Objects of the disclosure are not limited to the foregoing, and other unmentioned objects would be apparent to one of ordinary skill in the art from the following description.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

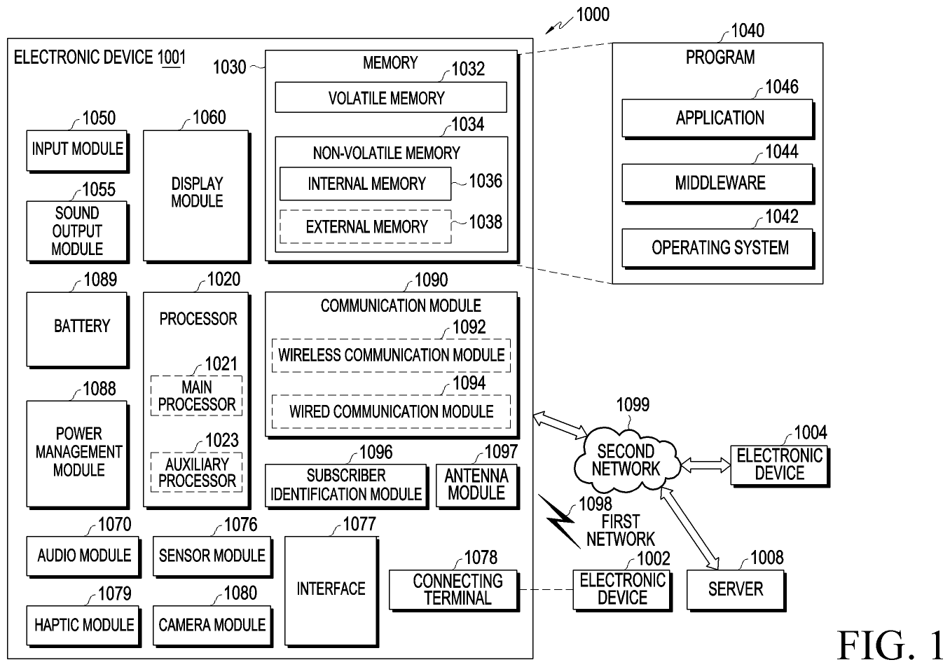

FIG. 1 is a block diagram illustrating an electronic device 1001 in a network environment 1000 according to an embodiment of the disclosure.

Referring to FIG. 1, the electronic device 1001 in the network environment 1000 may communicate with at least one of an electronic device 1002 via a first network 1098 (e.g., a short-range wireless communication network), or an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In an embodiment, at least one (e.g., the connecting terminal 1078) of the components may be omitted from the electronic device 1001, or one or more other components may be added in the electronic device 1001. According to an embodiment, some (e.g., the sensor module 1076, the camera module 1080, or the antenna module 1097) of the components may be integrated into a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034 (e.g., the internal memory 1036 and/or the external memory 1038). According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be configured to use lower power than the main processor 1021 or to be specified for a designated function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. The artificial intelligence model may be generated via machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by other component (e.g., the processor 1020) of the electronic device 1001, from the outside (e.g., a user) of the electronic device 1001. The input module 1050 may include, for example, a microphone, a mouse, a keyboard, keys (e.g., buttons), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display 1060 may include, for example, a display, a hologram device, or a projector and control circuitry to control a corresponding one of the display, hologram device, and projector. According to an embodiment, the display 1060 may include a touch sensor configured to detect a touch, or a pressure sensor configured to measure the intensity of a force generated by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., the electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or motion) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via a first network 1098 (e.g., a short-range communication network, such as Bluetooth™, wireless-fidelity (Wi-Fi) direct, or infrared data association (IrDA)) or a second network 1099 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 1092 may identify or authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the millimeter wave (mmWave) band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1097 may transmit or receive a signal or power to or from the outside (e.g., the external electronic device). According to an embodiment, the antenna module may include an antenna including a radiator formed of a conductor or conductive pattern formed on a substrate (e.g., a printed circuit board (PCB)). According to an embodiment, the antenna module 1097 may include a plurality of antennas (e.g., an antenna array). In this case, at least one antenna appropriate for a communication scheme used in a communication network, such as the first network 1098 or the second network 1099, may be selected from the plurality of antennas by, e.g., the communication module 1090. The signal or the power may then be transmitted or received between the communication module 1090 and the external electronic device via the selected at least one antenna. According to an embodiment, other parts (e.g., radio frequency integrated circuit (RFIC)) than the radiator may be further formed as part of the antenna module 1097.

According to an embodiment, the antenna module 1097 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 1001 and the external electronic device 1004 via the server 1008 coupled with the second network 1099. The external electronic devices 1002 or 1004 each may be a device of the same or a different type from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In an embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

The electronic device according to embodiment(s) of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment(s) of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities. Some of the plurality of entities may be separately disposed in different components. According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

In the following detailed description, a length direction, a width direction, and/or a thickness direction of the electronic device may be mentioned and may be defined as a ‘Y-axis direction,’ ‘X-axis direction’, and/or ‘Z-axis direction,’ respectively. In an embodiment, ‘negative/positive (−/+)’ may be mentioned together with the Cartesian coordinate system exemplified in the drawings with respect to the direction in which the component is oriented. For example, the front surface of the electronic device and/or housing may be defined as a ‘surface facing in the +Z direction,’ and the rear surface may be defined as a ‘surface facing in the −Z direction’. In an embodiment, the side surface of the electronic device and/or housing may include an area facing in the +X direction, an area facing in the +Y direction, an area facing in the −X direction, and/or an area facing in the −Y direction. In an embodiment, the ‘X-axis direction’ may mean including both the ‘−X direction’ and the ‘+X direction’. It should be noted that the directions are so defined with respect to the Cartesian coordinate system shown in the drawings for the sake of brevity of description, and the description of these directions or components do not limit an embodiment(s) of the disclosure. For example, the Cartesian coordinate system may be defined as different from that disclosed in the disclosure depending on the specifications of the electronic device or the user's usage habits.

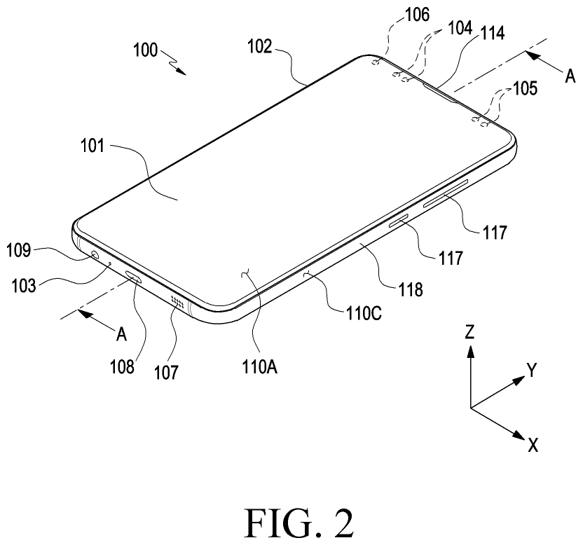

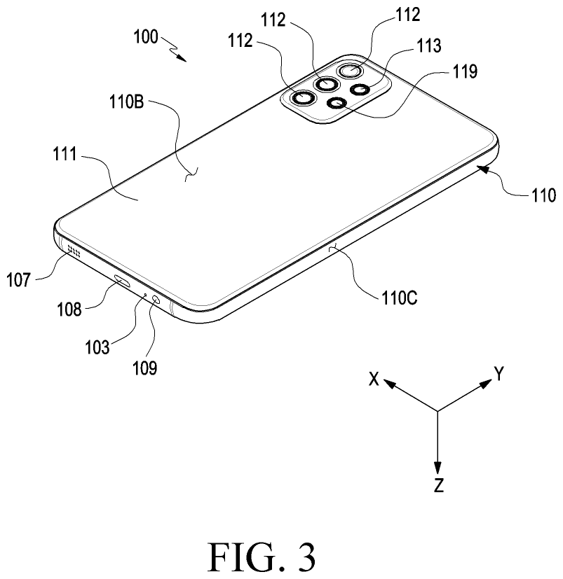

FIG. 2 is a front perspective view illustrating an electronic device 100 according to an embodiment of the disclosure. FIG. 3 is a perspective view illustrating a rear surface of the electronic device 100 of FIG. 2 according to an embodiment of the disclosure.

Referring to FIGS. 2 and 3, according to an embodiment, an electronic device 100 (e.g., the electronic device 1001 of FIG. 1) may include a housing 110 including a first surface (or front surface) 110A, a second surface (or rear surface) 110B, and a side surface 110C surrounding a space between the first surface 110A and the second surface 110B. According to an embodiment (not shown), the housing 110 may denote a structure forming the first surface 110A of FIG. 2, the second surface 110B of FIG. 3, and some of the side surfaces 110C. According to an embodiment, at least part of the first surface 110A may have a substantially transparent front plate 102 (e.g., a glass plate or polymer plate including various coat layers). The second surface 110B may be formed of a substantially opaque rear plate 111. The rear plate 111 may be formed of, e.g., laminated or colored glass, ceramic, polymer, metal (e.g., aluminum, stainless steel (STS), or magnesium), or a combination of at least two thereof. The side surface 110C may be formed by a side structure (or a “side bezel structure”) 118 that couples to the front plate 102 and the rear plate 111 and includes a metal and/or polymer. In an embodiment, the rear plate 111 and the side structure 118 may be integrally formed together and include the same material (e.g., a metal, such as aluminum).

Although not shown, the front plate 102 may include area(s) that bend from at least a portion of an edge toward the rear plate 111 and seamlessly extend. In an embodiment, only one of the areas of the front plate 102 (or the rear plate 111), which bend to the rear plate 111 (or front plate 102) and extend may be included in one edge of the first surface 110A. According to an embodiment, the front plate 102 or the rear plate 111 may have a substantially flat plate shape. For example, no bent and extended area may be included. When an area bending and extending is included, the thickness of the electronic device 100 at the portion including the area bending and extending may be smaller than the thickness of the rest.

According to an embodiment, the electronic device 100 may include at least one of a display 101, an audio module (e.g., the microphone hole 103, the external speaker hole 107, and the phone receiver hole 114), a sensor module (e.g., the first sensor module 104, the second sensor module (not illustrated), or the third sensor module 119), a camera module (e.g., the first camera device 105, the second camera device 112, or the flash 113), a key input device 117, a light emitting device 106, and a connector hole (e.g., the first connector hole 108 or the second connector hole 109). In an embodiment, the electronic device 100 may exclude at least one (e.g., the key input device 117 or the light emitting device 106) of the components or may add other components.

The display 101 may output a screen or be visually exposed through a significant portion of the first surface 110A (e.g., the front plate 102), for example. In an embodiment, at least a portion of the display 101 may be visually exposed through the front plate 102 forming the first surface 110A, or through a portion of the side surface 110C. In an embodiment, the edge of the display 101 may be formed to be substantially the same in shape as an adjacent outer edge of the front plate 102. In an embodiment (not illustrated), the interval between the outer edge of the display 101 and the outer edge of the front plate 102 may remain substantially even to give a larger area of visual exposure of the display 101.

In an embodiment (not shown), a recess or an opening may be formed in a portion of the screen display area of the display 101, and there may be included at least one of an audio module (e.g., the phone receiver hole 114), a sensor module (e.g., the first sensor module 104), a camera module (e.g., the first camera device 105), and a light emitting device 106 that are aligned with the recess or the opening. In an embodiment (not shown), at least one of the audio module (e.g., the phone receiver hole 114), sensor module (e.g., the first sensor module 104), camera module (e.g., the first camera device 105), fingerprint sensor (not shown), and light emitting device 106 may be included on the rear surface of the screen display area of the display 101. In an embodiment (not illustrated), the display 101 may be disposed to be coupled with, or adjacent, a touch detecting circuit, a pressure sensor capable of measuring the strength (pressure) of touches, and/or a digitizer for detecting a magnetic field-type stylus pen. In an embodiment, when the front plate 102 or the rear plate 111 includes a bent and extended area(s), at least some of the sensor modules (e.g., the first sensor module 104 and the third sensor module 119) and/or at least some of the key input devices 117 may be disposed in the bent and extended area(s).

The audio modules 103, 107, and 114 may include a microphone hole 103 and speaker holes (e.g., the external speaker hole 107 and the phone receiver hole 114). A microphone for acquiring external sounds may be disposed in the microphone hole 103. In an embodiment, a plurality of microphones may be disposed to detect the direction of the sound. The speaker holes may include an external speaker hole 107 and a phone receiver hole 114. According to an embodiment, the speaker holes (e.g., the external speaker hole 107 and the phone receiver hole 114) and the microphone hole 103 may be implemented as a single hole, or speakers may be included without the speaker holes (e.g., the external speaker hole 107 and the phone receiver hole 114) (e.g., piezo speakers).

The sensor module may generate an electrical signal or data value corresponding to an internal operating state or external environmental state of the electronic device 100. The sensor modules may include a first sensor module 104 (e.g., a proximity sensor) and/or a second sensor module (not shown) (e.g., a fingerprint sensor) disposed on the first surface 110A of the housing 110 and/or a third sensor module 119 disposed on the second surface 110B of the housing 110. The second sensor module (not shown) (e.g., a fingerprint sensor) may be disposed on the second surface 110B or side surface 110C as well as the first surface 110A (e.g., the display 101) of the housing 110. The electronic device 100 may further include, e.g., at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

The camera modules may include a first camera device 105 disposed on the first surface 110A of the electronic device 100, and a second camera device 112 and/or a flash 113 disposed on the second surface 110B. The camera devices (e.g., the first camera device 105 and the second camera device 112) may include one or more lenses, an image sensor, and/or an image signal processor. The flash 113 may include, e.g., a light emitting diode or a xenon lamp. In an embodiment, one or more lenses (an infrared (IR) camera, a wide-angle lens, and a telephoto lens) and image sensors may be disposed on one surface of the electronic device 100. In an embodiment, flash 113 may emit infrared light. The infrared light emitted by the flash 113 and reflected by the subject may be received through the third sensor module 119. The electronic device 100 or the processor (e.g., the processor 1020 of FIG. 1) of the electronic device 100 may detect depth information about the subject based on the time point when the infrared light is received from the third sensor module 119.

The key input device 117 may be disposed on the side surface 110C of the housing 110. In an embodiment, the electronic device 100 may exclude all or some of the above-mentioned key input devices 117 and the excluded key input devices 117 may be implemented in other forms, e.g., as soft keys, on the display 101. In an embodiment, the key input device may include the sensor module disposed on the second surface 110B of the housing 110.

The light emitting device 106 may be disposed on, e.g., the first surface 110A of the housing 110. The light emitting device 106 may provide, e.g., information about the state of the electronic device 100 in the form of light. In an embodiment, the light emitting device 106 may provide a light source that interacts with, e.g., the camera module (e.g., the first camera device 105). The light emitting device 106 may include, e.g., a light emitting diode (LED), an infrared (IR) LED, or a xenon lamp.

The connector holes (e.g., the first connector hole 108 or the second connector hole 109) may include, e.g., a first connector hole 108 for receiving a connector (e.g., a USB connector) for transmitting/receiving power and/or data to/from an external electronic device (e.g., the electronic device 1002 of FIG. 1) and/or a second connector hole 109 (e.g., an earphone jack) for receiving a connector for transmitting/receiving audio signals to/from the external electronic device.

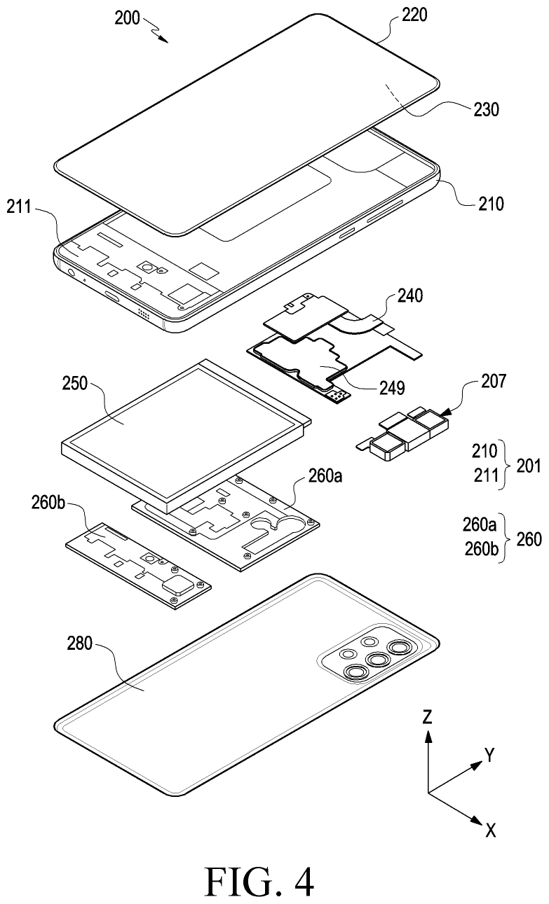

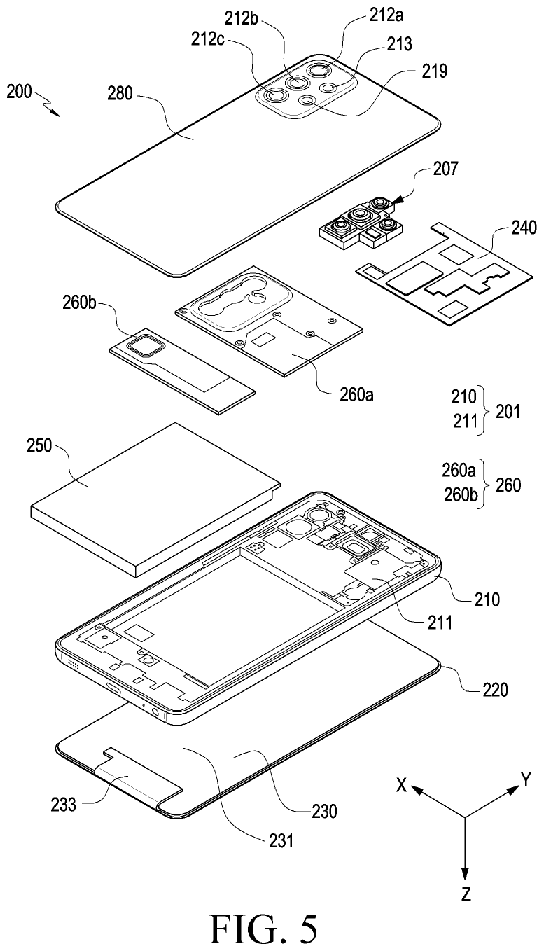

FIG. 4 is an exploded front perspective view illustrating an electronic device 200 (e.g., the electronic device 100 of FIG. 2), according to an embodiment of the disclosure. FIG. 5 is a rear exploded perspective view illustrating an electronic device 200 (e.g., the electronic device 100 of FIG. 2) according to an embodiment of the disclosure.

Referring to FIGS. 4 and 5, an electronic device 200 (e.g., the electronic device 1001, 1002, 1004, or 100 of FIG. 1, 2, or 3) may include a side structure 210, a first supporting member 211 (e.g., a bracket), a front plate 220 (e.g., the front plate 102 of FIG. 1), a display 230 (e.g., the display 101 of FIG. 1), a printed circuit board (or a board assembly) 240, a battery 250, a second supporting member 260 (e.g., a rear case), an antenna (not shown) (e.g., the antenna module 1097 of FIG. 1), a camera assembly 207, and a rear plate 280 (e.g., the rear plate 111 of FIG. 3). In an embodiment, the electronic device 200 may exclude at least one (e.g., the first supporting member 211 or the second supporting member 260) of the components or may add other components. At least one of the components of the electronic device 200 may be the same or similar to at least one of the components of the electronic device 100 of FIG. 2 or 3 and no duplicate description is made below.

The first supporting member 211 may be disposed inside the electronic device 200 to be connected with the side structure 210 or integrated with the side structure 210. The first supporting member 211 may be formed of, e.g., a metal and/or non-metallic material (e.g., polymer). When at least partially formed of a metallic material, a portion of the side structure 210 or the first supporting member 211 may function as an antenna. The display 230 may be joined onto one surface of the first supporting member 211, and the printed circuit board 240 may be joined onto the opposite surface of the first supporting member 211. A processor (e.g., the processor 1020 of FIG. 1), memory (e.g., the memory 1030 of FIG. 1), and/or an interface (e.g., the interface 1077 of FIG. 1) may be mounted on the printed circuit board 240. The processor may include one or more of, e.g., a central processing unit, an application processor, a graphic processing device, an image signal processing, a sensor hub processor, or a communication processor. In an embodiment, processor and/or memory may refer to one of the circuit devices mounted in an integrated circuit chip.

According to an embodiment, the first supporting member 211 and the side structure 210 may be collectively referred to as a portion of a front case or a housing 201. According to an embodiment, the housing 201 may be generally understood as a structure for receiving, protecting, or disposing the printed circuit board 240 or the battery 250. In an embodiment, the housing 201 may be understood as including a structure that the user may visually or tactfully recognize from the exterior of the electronic device 200, e.g., the side structure 210, the front plate 220, and/or the rear plate 280. In an embodiment, the ‘front or rear surface of the housing 201’ may refer to the first surface 110A of FIG. 2 or the second surface 110B of FIG. 3. In an embodiment, the first supporting member 211 may be disposed between the front plate 220 (e.g., the first surface 110A of FIG. 2) and the rear plate 280 (e.g., the second surface 110B of FIG. 3) and may function as a structure for placing an electrical/electronic component, such as the printed circuit board 240 or the camera assembly 207.

The display 230 may include a display panel 231 and a flexible printed circuit board 233 extending from the display panel 231. It may be understood that the flexible printed circuit board 233 is, e.g., electrically connected to the display panel 231 while at least partially disposed on the rear surface of the display panel 231. In an embodiment, reference number ‘231’ may be understood as a protective sheet disposed on the rear surface of the display panel. For example, the protective sheet may be understood as a portion of the display panel 231 unless otherwise designated in the detailed description below. In an embodiment, the protective sheet may function as a cushioning structure that absorbs external force (e.g., a low-density elastic material, such as a sponge) or an electromagnetic shielding structure (e.g., a copper sheet (CU sheet)). According to an embodiment, the display 230 may be disposed on the inner surface of the front plate 220 and, by including a light emitting layer, output a screen through at least a portion of the front plate 220 or the first surface 110A of FIG. 2. As mentioned above, the display 230 may output substantially the entire area of the front plate 220 or the first surface 110A of FIG. 2.

The memory may include, e.g., volatile or non-volatile memory.

The interface may include, e.g., a high definition multimedia interface (HDMI), a universal serial bus (USB) interface, a secure digital (SD) card interface, and/or an audio interface. The interface may electrically or physically connect, e.g., the electronic device 200 with an external electronic device and may include a USB connector, an SD card/multimedia card (MMC) connector, or an audio connector.

The second supporting member 260 may include, e.g., an upper supporting member 260a and/or a lower supporting member 260b. In an embodiment, the upper supporting member 260a, together with a portion of the first supporting member 211, may be disposed to surround the printed circuit board 240. For example, the printed circuit board 240 may be substantially disposed between the first supporting member 211 and the second supporting member 260 (e.g., upper supporting member 260a). A circuit device (e.g., a processor, a communication module, or memory) implemented in the form of an integrated circuit chip or various electrical/electronic components may be disposed on the printed circuit board 240. According to an embodiment, the printed circuit board 240 may receive an electromagnetic shielding environment from the upper supporting member 260a. In an embodiment, at least one shield can 249 may be disposed on the printed circuit board 240. For example, the shield can 249 may provide an electromagnetic shielding environment to some areas or spaces on the printed circuit board 240. In an embodiment, the shield can 249 may be disposed to surround at least a portion of an integrated circuit chip where a processor, memory, and/or communication module is mounted.

According to an embodiment, the lower supporting member 260b may be utilized as a structure in which electrical/electronic components, such as a speaker module and an interface (e.g., a USB connector, an SD card/MMC connector, or an audio connector) may be disposed. In an embodiment, electrical/electronic components, such as a speaker module and an interface (e.g., a USB connector, an SD card/MMC connector, or an audio connector) may be disposed on an additional printed circuit board (not shown). For example, the lower supporting member 260b, together with the other part of the first supporting member 211, may be disposed to surround the additional printed circuit board. A speaker module or interface disposed on an additional printed circuit board (not shown) or lower supporting member 260b may be disposed corresponding to the connector hole (e.g., the first connector hole 108 or the second connector hole 109) or the audio module (e.g., the microphone hole 103 or the speaker hole (e.g., the external speaker hole 107 or the phone receiver hole 114)) of FIG. 2.

The battery 250 may be a device for supplying power to at least one component of the electronic device 200. The battery 250 may include, e.g., a primary cell which is not rechargeable, a secondary cell which is rechargeable, or a fuel cell. At least a portion of the battery 250 may be disposed on substantially the same plane as the printed circuit board 240. The battery 250 may be integrally or detachably disposed inside the electronic device 200.

Although not shown, the antenna may include a conductor pattern implemented on the surface of the first supporting member 211 and/or the surface of the second supporting member 260 through, e.g., laser direct structuring (LDS). In an embodiment, the antenna may include a printed circuit pattern formed on the surface of the thin film. The thin film-type antenna may be disposed between the rear plate 280 and the battery 250. The antenna may include, e.g., a near-field communication (NFC) antenna, a wireless charging antenna, and/or a magnetic secure transmission (MST) antenna. The antenna may perform short-range communication with, e.g., an external device or may wirelessly transmit or receive power necessary for charging. In an embodiment of the disclosure, another antenna structure may be formed by a portion or combination of the side structure 210 and/or the first supporting member 211.

The camera assembly 207 may include at least one camera module. Inside the electronic device 200, the camera assembly 207 may receive at least a portion of the light incident through the optical hole or the camera windows 212a, 212b, 212c, 213, and 219. In an embodiment, the camera assembly 207 may be disposed on the first supporting member 211 in a position adjacent to the printed circuit board 240. In an embodiment, the camera module(s) of the camera assembly 207 may be generally aligned with either one of the camera windows 212a, 212b, 212c, 213, and 219 and be a least partially surrounded by the second supporting member 260 (e.g., the upper supporting member 260a).

The following embodiments may be described with reference to the above-described configurations of the electronic devices 1001, 1002, 1004, 100, and 200. Even when not directly mentioned, the above-described configurations of the embodiments may likewise apply to the following embodiments. The orthogonal coordinate system referenced in the foregoing and/or following embodiments is exemplified for brevity of description and may be differently defined depending on the type (e.g., bar type, foldable type, rollable type, and/or slidable type) of the electronic device to be actually manufactured, the user's use habit, and/or the orientation of the electronic device. In the embodiments to be described below, the components that may be easily understood through the above-described embodiments may be denoted by the same reference numerals or without reference numerals and, although the reference numerals are given, the detailed description thereof may also be omitted.

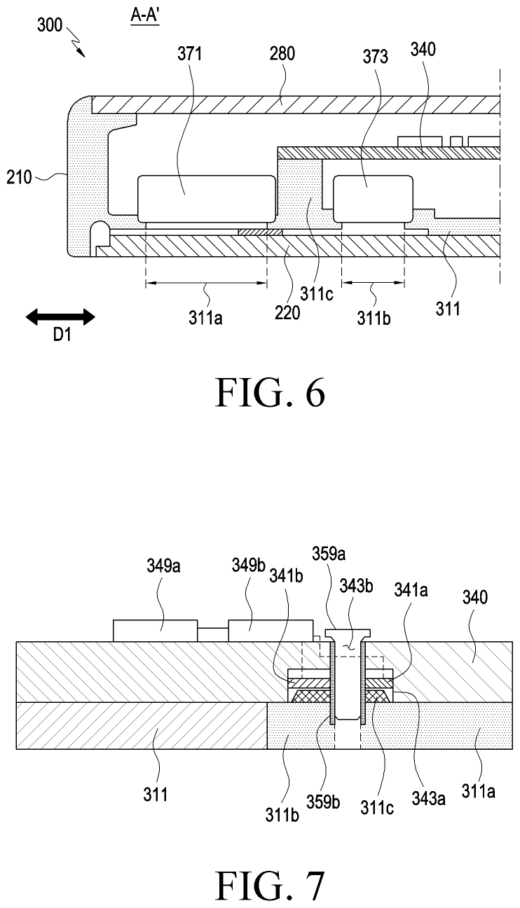

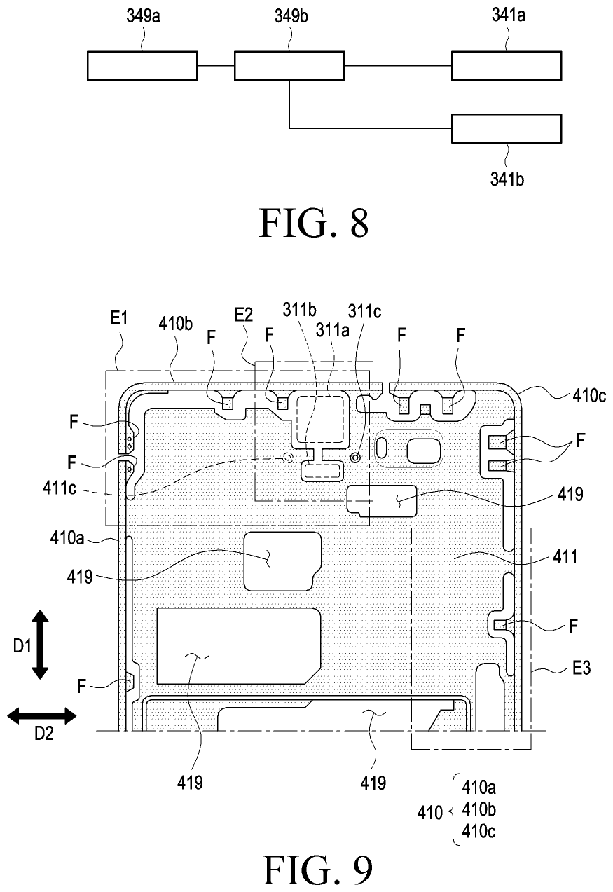

FIG. 6 is a view taken along line A-A′ of FIG. 2 in an electronic device 300 (e.g., the electronic device 1001, 1002, 1004, 100, or 200 of FIGS. 1 to 5) according to an embodiment of the disclosure. FIG. 7 is a view illustrating an example of an electrical connecting structure implemented in an electronic device 300 according to an embodiment of the disclosure. FIG. 8 is a view illustrating an example of an electrical connecting structure implemented in an electronic device 300 according to an embodiment of the disclosure.

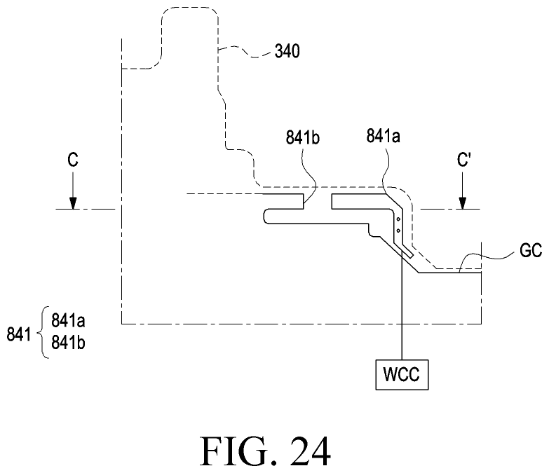

Referring to FIGS. 6 to 8, the electronic device 300 may perform wireless communication using a portion of a structure (e.g., the first supporting member 211 or 311 of FIGS. 4 to 7) disposed inside the housing (e.g., the housing 201 of FIG. 4 or 5). For example, a portion of the inner structure may be electrically connected to the printed circuit board 340 (e.g., the printed circuit board 240 of FIG. 4 or 5). Here, that “a portion of the inner structure is electrically connected to the printed circuit board” may mean that a portion of the inner structure includes an electrically conductive material, and at least a portion of the portion of the inner structure including the electrically conductive material is electrically connected to a wireless communication circuit (e.g., the communication module 1090 of FIG. 1 or the wireless communication circuit WCC of FIG. 24) to function as an antenna. In an embodiment, the memory 1030 may store instructions executed by at least one processor 1020, and the processor 1020 may be configured to execute the instruction(s) to enable the electronic device 300 to perform wireless communication in a designated frequency band using an inner structure. In an embodiment, when electrically connected to the printed circuit board 340, the inner structure may provide a plurality of resonant frequencies. In an embodiment, the inner structure may provide a plurality of resonant frequencies in performing wireless communication of the same communication protocol.

According to an embodiment, the electronic device 300 may perform wireless communication using at least a portion of the side structure 210 (e.g., the side structure 210 of FIGS. 4 to 6), separately from the inner structure. In an embodiment, wireless communication using the side structure 210 may be performed in an independent state for wireless communication using the inner structure. Here, that “an inner structure or a side structure is used for wireless communication” may mean that at least a portion of the inner structure (e.g., the first supporting member 211 or 311 of FIGS. 4 to 7) or at least a portion of the side structure 210 includes an electrically conductive material. In an embodiment, when a portion of the side structure 210 is used for wireless communication, the portion is electrically insulated from the rest of the side structure 210 but may be mechanically connected or coupled thereto.

According to an embodiment, the electronic device 300 may include a housing 201, a first supporting member 311, an opening(s) 311a, 311b provided to penetrate the first supporting member 311, a printed circuit board 340, at least one processor (e.g., the processor 1020 of FIG. 1) (or a communication circuit (e.g., the communication module 1090 of FIG. 1), and/or memory (e.g., the memory 1030 of FIG. 1) and may perform wireless communication in a first frequency band using at least a portion of the first supporting member 311 around the opening(s) 311a, 311b. In an embodiment, a first opening 311a penetrating the first supporting member 311 and a second opening 311b penetrating the first supporting member 311a at a position adjacent to the first opening 311a may be provided. In an embodiment, when the first opening 311a and the second opening 311b are provided, a plurality of resonant frequencies may be implemented according to the relative sizes of the first opening 311a and the second opening 311b. For example, for convenience of description, it was mentioned that ‘wireless communication in the first frequency band is performed using at least a portion of the first supporting member’, but the ‘first frequency band’ may be understood as including a configuration that performs wireless communication of the same communication protocol but forms two different resonant frequencies.

According to an embodiment, the housing 201 may include a front plate (e.g., the front plate 220 of FIG. 4 or 5) and a rear plate (e.g., the rear plate 280 of FIG. 4 or 5) disposed opposite to the front plate. In an embodiment, a space between the front plate 220 and the rear plate 280 may be provided as a space for accommodating or arranging electrical/electronic components such as a printed circuit board 340 (e.g., the printed circuit board 240 of FIG. 4 or 5). As in the above-described embodiment, the ‘housing’ may refer to a structure that the user may visually or tactically recognize in the appearance of the electronic device 300. For example, the housing 201 may further include a side structure 210 (e.g., the side structure 210 of FIG. 4 or 5) surrounding the space between the front plate 220 and the rear plate 280. In an embodiment, when the first supporting member 311 is integrally formed with the side structure 210, the first supporting member 311 may be understood as a portion of the housing 201 even if it is not visually or tactically recognized by the user. For example, although the first supporting member 311 may be described as a separate component from the housing 201, this is for simplicity of description, and it may be understood that the housing 201 includes the first supporting member 311.

According to an embodiment, the first supporting member 311 is disposed in a space between the front plate 220 and the rear plate 280 and may include a coupling boss 311c provided on one surface thereof. In an embodiment, the first supporting member 311 has a plate shape substantially similar to that of the front plate 220 or the rear plate 280, and may include an opening(s) (e.g., the first opening 311a or the second opening 311b), a recess(es), and/or a partition(s) according to the arrangement of electrical/electronic components therein. For example, the first supporting member 311 may have a plate shape including a portion depressed or protruding from the surface. In an embodiment, the first supporting member 311 is one of the inner structures that may be used for wireless communication, and may at least partially include an electrically conductive material. For example, the first supporting member 311 may function as an antenna or radiating conductor by at least partially including an electrically conductive material.

According to an embodiment, the coupling boss 311c is a structure protruding from one surface of the first supporting member 311, and may support, e.g., the printed circuit board 340. In an embodiment, a plurality of coupling bosses 311c may be provided on one surface (or two opposite surfaces) of the first supporting member 311. In an embodiment, the coupling boss 311c is described as a portion of the first supporting member 311, but may be a structure for forming a gap between the first supporting member 311 and the printed circuit board 340. For example, by being supported by the coupling boss 311c of the printed circuit board 340, a gap may be formed between the first supporting member 311 and the printed circuit board 340 as high as the height of the coupling boss 311c (e.g., the height protruding from one surface of the first supporting member 311). In an embodiment, the gap between the first supporting member 311 and the printed circuit board 340 may provide a space in which electrical/electronic components disposed on the printed circuit board 340 are to be positioned.

According to an embodiment, the electronic device 300 may include the opening(s) 311a, 311b provided to penetrate a supporting member (e.g., the first supporting member 311). The opening(s) 311a, 311b may be understood, e.g., as a portion of the first supporting member 311. In the illustrated embodiment, a first opening 311a provided to penetrate the first supporting member 311 at a designated position and a second opening 311b provided to penetrate the first supporting member 311 at a position adjacent to the first opening 311a may be illustrated. In an embodiment, it may be understood that the first opening 311a and the second opening 311b are aligned in the first direction D1, e.g., a direction parallel to the Y-axis of FIG. 5. However, in the embodiment(s) of the disclosure, the number and alignment direction of openings 311a and 311b may be implemented to differ in the first supporting member 311 depending on the arrangement of the component(s) inside and thus it should be noted that the ‘first direction D1’ is not limited to the direction parallel to the Y-axis of FIG. 5. For example, the ‘alignment direction of the first opening 311a and the second opening 311b’ mentioned in the embodiments of the disclosure may be understood as including a direction parallel to the Y-axis of FIG. 5, a direction parallel to the X-axis of FIG. 5, and/or a direction inclined rather than perpendicular to the Y-axis.

According to an embodiment, as mentioned above, the printed circuit board 340 may be supported by the coupling boss 311c and disposed on the first supporting member 311. Although the coupling boss 311c is described as being a portion of the first supporting member 311, it may be understood that the printed circuit board 340 is disposed at a designated height from one surface of the first supporting member 311. In an embodiment, the printed circuit board 340 may be electrically connected to the first supporting member 311 through the coupling boss 311c. For example, it may be understood that at least the coupling boss 311c of the first supporting member 311 includes an electrically conductive material.

According to an embodiment, the coupling boss 311c may be disposed adjacent to the first opening 311a. In an embodiment, when the coupling boss 311c is disposed adjacent to the first opening 311a, a portion of the first supporting member 311 forming the circumference of the first opening 311a may include a substantially electrically conductive material. For example, in the portion that defines the first opening 311a while connecting to the coupling boss 311c and the coupling boss 311c, the first supporting member 311 may include an electrically conductive material. Thus, of the first supporting member 311, at least the circumferential portion of the first opening 311a and/or the coupling boss 311c may function as an antenna (or a radiating conductor).

According to an embodiment, the electronic device 300 may further include a fastening member(s) 359a. For example, the fastening member 359a may pass through the fastening hole 343b provided in the printed circuit board 340 and be bound to the first supporting member 311 (e.g., the coupling boss 311c). In an embodiment, when the printed circuit board 340 is electrically connected to the first supporting member 311 through the coupling boss 311c, an insulating member 359b may be further provided on the inner wall of the fastening hole 343b and/or the outer circumferential surface of the fastening member 359a. For example, when the printed circuit board 340 is electrically connected to the first supporting member 311 through the coupling boss 311c, the fastening member 359a that is fastened to the coupling boss 311c may be electrically insulated from the inner wall of the fastening hole 343b and/or the coupling boss 311c. In an embodiment, when the fastening member 359a is a bolt or screw, the head of the fastening member 359a may be electrically connected to the ground conductor of the printed circuit board 340.

In an embodiment, the second opening 311b adjacent to the first opening 311a may be disposed adjacent to the coupling boss 311c. In an embodiment, when it is defined that the first opening 311a and the second opening 311b are aligned along the first direction D1, the coupling boss 311c may be disposed on one side of the first opening 311a or on one side of the second opening 311b in the second direction D2 crossing the first direction D1. When the second opening 311b is disposed adjacent to the coupling boss 311c, the first supporting member 311 may include an electrically conductive material in at least a portion of the circumference of the second opening 311b. For example, by including the electrically conductive material in the portion that defines the second opening 311b, the first supporting member 311 may provide an antenna that extends further from the first opening 311a, or an antenna that is independent of the first opening 311a. For example, as the coupling boss 311c, a portion of the first supporting member 311 of the portion surrounding the first opening 311a, and/or a portion of the first supporting member 311 of the portion surrounding the second opening 311b are electrically connected to the printed circuit board 340, a portion of the first supporting member 311 provided as an inner structure may implement an antenna(s).

According to an embodiment, when the coupling boss 311c is provided adjacent to the circumference of the first opening 311a and/or the second opening 311b, and/or when the first supporting member 311 and the printed circuit board 340 are electrically connected through the coupling boss 311c, the electronic device 300 may be configured to perform wireless communication in the first frequency band using a portion of the first supporting member 311. Here, “electrically connected” may be understood to include a structure in which the coupling boss 311c is in direct contact with the feeding pad 341a and 341b, which is described below, and a structure in which the coupling boss 311c and the feeding pad 341a, 341b are disposed within a designated distance to form an electromagnetic coupling, even if they are not in direct contact. In an embodiment, the memory 1030 may store instructions configured to allow the electronic device 300 to perform wireless communication using at least a portion of the first supporting member 311 around the first opening 311a or the second opening 311b, and the instructions may be executed by each of the processor(s) 1020 or by a combination of processors.

According to an embodiment, the first opening 311a may provide a space for disposing the camera module 371 (e.g., the camera device 105 or 112 of FIG. 2 or 3), and/or the second opening 311b may provide a space for disposing the sensor module 373 (e.g., the first sensor module 104 of FIG. 2). The sensor module 373 disposed in the second opening 311b may include, e.g., a sensor for detecting an operating environment such as a proximity sensor or an illuminance sensor. In an embodiment, when using the circumference of the opening 311a, 311b of the camera and/or sensor as an antenna, the first supporting member 311 may form a resonant frequency in a frequency band of about 6.5 GHz and/or a frequency band of about 8 GHZ.

According to an embodiment, the resonant frequency formed by the first supporting member 311 providing the opening(s) 311a, 311b may differ depending on the specifications of the electronic device to be actually manufactured. For example, according to the size of the first opening 311a and the second opening 311b, a resonant frequency may be formed in a frequency band different from the 6.5 GHz frequency band and/or about 8 GHz frequency band. In an embodiment, as the size of the opening 311a, 311b increases, the resonant frequency may decrease. In an embodiment, as the distance from the coupling boss 311c increases, the electrical length provided by the electrically conductive portion around the opening 311a, 311b may increase, and the resonant frequency provided by the inner structure (e.g., the first supporting member 311) as a radiating conductor may decrease. For example, when implementing an antenna or radiating conductor using an inner structure, the size and relative position of the opening(s) 311a, 311b and/or the electrical length provided by the path from the coupling boss 311c to the opening 311a, 311b (e.g., the electrically conductive portion around the opening 311a, 311b) may be considered. Accordingly, according to the specifications of the electronic device 300 to be actually manufactured, the antenna using the first supporting member 311 may form a resonant frequency in an arbitrarily selected frequency band.

According to an embodiment, the printed circuit board 340 may include a fill-cut area 343a and at least one feeding pad 341a and 341b provided in the fill-cut area 343a. For example, the feeding pad(s) 341a, 341b may be spaced apart or in direct contact with the coupling boss 311c. In an embodiment, when the printed circuit board 340 is a multilayer circuit board, “at least one feeding pad is provided in the fill-cut area” may refer to a structure in which the feeding pad(s) 341a, 341b is disposed in a layer disposed inside among the plurality of layers, and other conductive layers (and/or insulating layers) are removed from a portion corresponding to the feeding pad(s) 341a, 341b. In an embodiment, “feeding pad(s) 341a, 341b is disposed to face the coupling boss 311c” may refer to the feeding pad(s) 341a, 341b being disposed within a distance from the coupling boss 311c, at which an electromagnetic coupling or coupling feeding may be formed, although not in direct contact with the coupling boss 311c. In an embodiment, an insulating material may be provided between the feeding pad(s) 341a, 341b and the coupling boss 311c in a structure in which the feeding pad(s) 341a, 341b is disposed to face the coupling boss 311c.

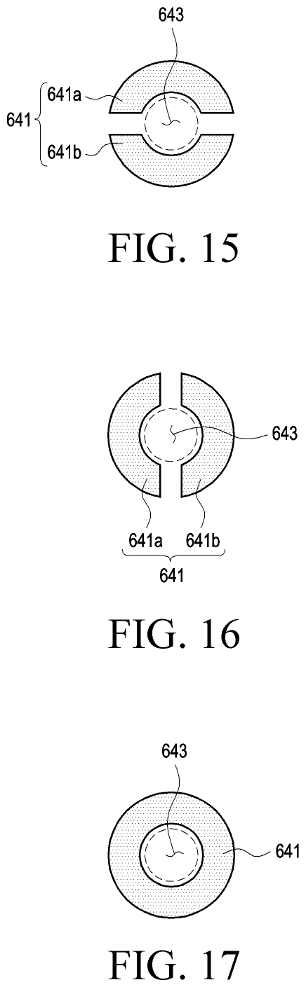

According to an embodiment, the fastening hole 343b may be provided to substantially penetrate the fill-cut area 343a. In an embodiment, the feeding pad(s) 341a, 341b may be disposed adjacent to the fastening hole 343b. Here, “disposed adjacent to the fastening hole” may be understood as including a structure disposed not to be in direct contact with the fastening hole 343b. In an embodiment, the feeding pad(s) 341a, 341b may be disposed at a designated interval from the fastening hole 343b. For example, the feeding pad(s) 341a, 341b may be disposed to be in direct contact with the coupling boss 311c or to form an electromagnetic coupling without being in direct contact with the coupling boss 311c. In an embodiment, the plurality of feeding pads 341a and 341b may be provided, and in this case, it may be understood that the feeding pads 341a and 341b are disposed around the fastening hole 343b. In an embodiment, referring to FIG. 12, the feeding pad 341a and 341b may include extending portions (e.g., extending portions 541c and 541d of FIG. 15) extending in one direction, and the extending portions may be disposed substantially side by side with the first opening 311a or the second opening 311b. For example, the number, shape, and/or disposition position of the feeding pad(s) 341a, 341b may differ depending on the specifications of the electronic device to be actually manufactured.

According to an embodiment, the printed circuit board 340 may include a first switching element 349b connecting the feeding pad(s) 341a, 341b and the communication circuit (the communication module 1090 of FIG. 1). For example, at least one feeding pad 341a, 341b may be electrically connected to a communication circuit and/or at least one processor via the first switching element 349b. In FIG. 7 or 8, it may be understood that the communication circuit is mounted on the integrated circuit chip 349a disposed on the printed circuit board 340. It should be noted that the first switching element 349b may include, e.g., a duplexer (DPX), a multiplexer (MPX), a single pole double-through (SPDT) switch, or a double pole double-through (DPDT) switch, but is not limited thereto. The first switching element 349b may be used, e.g., to separate a path between a transmission signal and a reception signal, or to select the feeding pad 341a, 341b to be used for transmission and reception in a structure in which a plurality of feeding pad 341a and 341b are provided. Accordingly, the electronic device 300 may select a transmission/reception operation of a wireless signal or a frequency at which the current wireless communication is to be performed using the first switching element 349b.

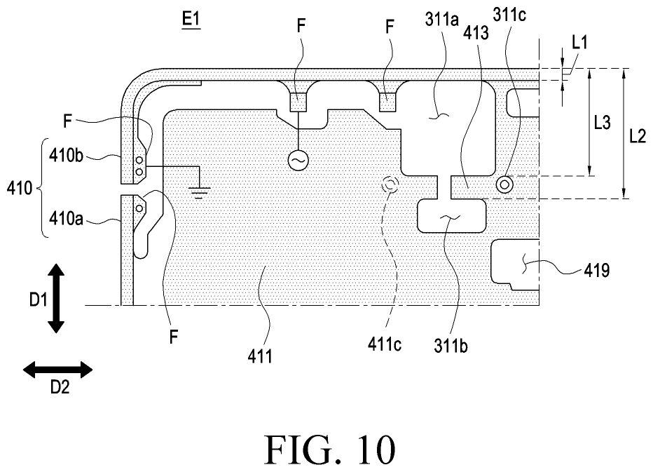

FIG. 9 is a plan view illustrating a first supporting member 411 (e.g., the first supporting member 211 or 311 of FIGS. 4 to 7) of an electronic device (e.g., the electronic device 300 of FIG. 6) according to an embodiment of the disclosure. FIG. 10 is an enlarged view illustrating portion E1 of FIG. 9 of a first supporting member 411 of an electronic device 300 according to an embodiment of the disclosure.

Referring to FIGS. 9 and 10, the electronic device 300 may include a side structure 410 (e.g., the side structure 210 of FIGS. 4 to 6) and a first supporting member 411 (e.g., the first supporting member 311 of FIG. 6). In an embodiment, the side structure 410 and the first supporting member 411 may include an electrically conductive material. In the illustrated embodiment, at least a portion of the dark area may illustrate an area including an electrically conductive material of the side structure 410 and the first supporting member 411. In an embodiment, the bright area to which the shading is not applied may illustrate the opening(s) 311a, 311b, 419 (e.g., the first opening 311a and the second opening 311b of FIG. 6) provided by the first supporting member 411, and/or an empty space between the side structure 410 and the first supporting member 411. In an embodiment, the empty space between the side structure 410 and the first supporting member 411 may be at least partially filled with an electrically insulating material such as a polymer to mechanically connect the side structure 410 and the first supporting member 411.

According to an embodiment, the side structure 410 may have a closed curve shape or a polygonal shape substantially surrounding the circumference of the first supporting member 411. For example, the side structure 410 may be disposed to at least partially surround a space between the front plate (e.g., the front plate 220 of FIGS. 4 to 6) and the rear plate (e.g., the rear plate 280 of FIGS. 4 to 6). In an embodiment, the side structure 410 may include a first frame 410a, a second frame 410b, and/or a third frame 410c disposed to form a closed curve trajectory. In an embodiment, the number of frames forming the side structure 410 may be different from the configuration shown depending on the actual product. In an embodiment, the first frame 410a, the second frame 410b, and/or the third frame 410c may illustrate a portion of the side structure 410 that substantially includes an electrically conductive material.

According to an embodiment, an empty space may be disposed between an end portion of the first frame 410a and an end portion of the second frame 410b and/or between an end portion of the second frame 410b and an end portion of the third frame 410c. For example, when the first frame 410a, the second frame 410b, and/or the third frame 410c includes an electrically conductive material, the second frame 410b may be electrically insulated from the first frame 410a and/or the third frame 410c. Although not illustrated, the space between the first frame 410a and the second frame 410b and/or the space between the second frame 410b and the third frame 410c is filled with an electrically insulating material, mechanically connecting (or coupling) the second frame 410b to the first frame 410a and/or the third frame 410c while electrically insulating the second frame 410b from the first frame 410a or the third frame 410c. In an embodiment, the electrically insulating structure that mechanically connects (or couples) the second frame 410b to the first frame 410a and/or the third frame 410c may be understood as a portion of the side structure 410.

According to an embodiment, a portion (e.g., the second frame 410b) of the side structure 410 may be provided as a structure surrounding a portion of the first opening 311a or defining a portion of the first opening 311a. For example, a portion of an inner surface of the second frame 410b may be provided as an inner wall of the first opening 311a. In an embodiment, the first supporting member 411 may include a plurality of opening 311a, 311b, and 419, and a portion of the opening (e.g., the first opening 311a) provided at a position adjacent to the side structure 410 among the plurality of opening 311a, 311b, and 419 may be understood as being defined by the second frame 410b.

According to an embodiment, a coupling boss(es) 311c may be provided to the first supporting member 411 at a first position adjacent to the selected opening(s) among the plurality of opening 311a, 311b, and 419. For example, when the printed circuit board 340 is disposed on the coupling boss 311c, a portion of the first supporting member 411 may function as an antenna or radiating conductor around the selected opening(s). In an embodiment, when the printed circuit board 340 is disposed on the coupling boss 311c and a portion of the first supporting member 411 is electrically connected to the communication circuit around the selected opening(s) to implement an antenna or radiating conductor, the coupling boss 311c may function as a portion (or feeding point) of the power supply path. Although the coupling boss 311c disposed adjacent to the first opening 311a and the second opening 311b is illustrated in the drawings for simplicity of description, it should be noted that the embodiment(s) of the disclosure are not limited thereto. For example, an additional coupling boss(s) adjacent to at least one of the openings indicated by reference number ‘419’ may be provided, and an antenna may be implemented around the opening adjacent to the additional coupling boss. In an embodiment, the first supporting member 411 may further provide a second coupling boss 411c disposed adjacent to the first opening 311a and the second opening 311b.

According to an embodiment, the side structure 410 or housing 201 may include, e.g., a flange(s) F protruding from the inner surface of the first frame 410a, the second frame 410b, and/or the third frame 410c. When the insulating material filling the space between the side structure 410 and the first supporting member 411 is included, at least a portion of the flange(s) F may contact or be buried in the insulating structure. For example, the flange(s) F may increase the bonding strength between the electrically conductive portion and the insulating structure and enhance the mechanical stability of the electronic device 300.

According to an embodiment, any one of the flanges F may be electrically connected to the communication circuit (e.g., the communication module 1090 of FIG. 1 or the integrated circuit chip 349a of FIG. 7) of the printed circuit board 340, and/or another one of the flanges F may be electrically connected to the ground. A portion electrically insulated from another portion of the side structure 410 and electrically connected to the communication circuit and/or at least one processor through any one of the flanges F may function as a radiating conductor. In the illustrated embodiment, one of the flanges F protruding from the second frame 410b may be implemented as a radiating conductor by being electrically connected to the feeding portion or the communication circuit. In an embodiment, another one of the flanges F protruding from the second frame 410b implemented as a radiating conductor may be electrically connected to the ground.

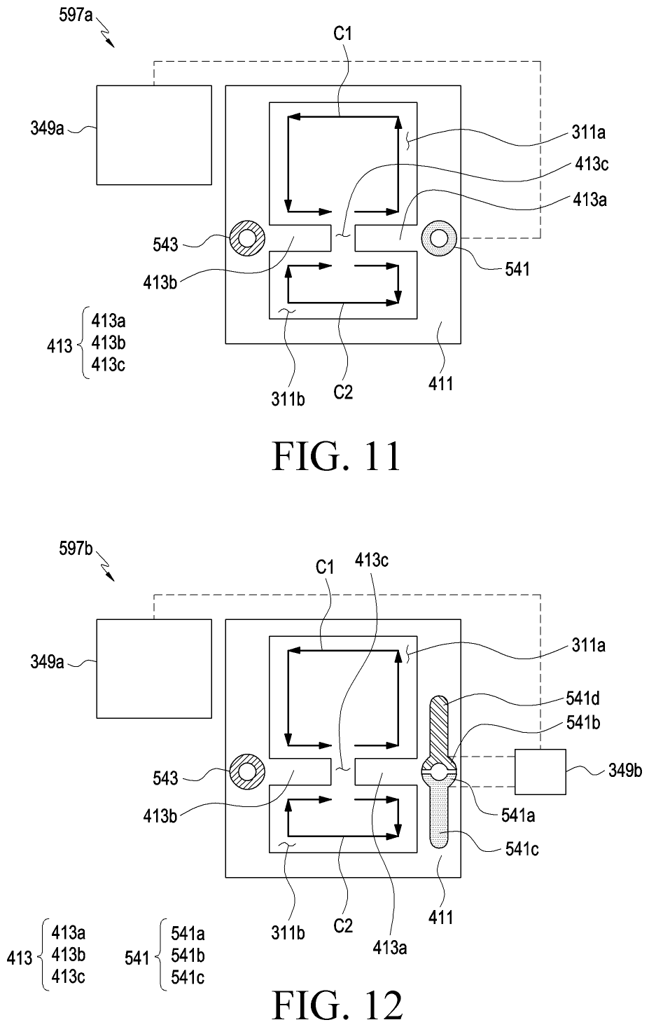

According to an embodiment, it may be provided to the first supporting member 411 in a state in which the first opening 311a and the first opening 311a are aligned along the first direction D1 from the side structure 410, e.g., the second frame 410b. In an embodiment, a dividing bar 413 (e.g., the dividing bar 413 of FIG. 11) may be provided between the first opening 311a and the second opening 311b. For example, the dividing bar 413 may be understood as a structure that simultaneously defines a portion of the first opening 311a and a portion of the second opening 311b. In an embodiment, the first supporting member 411 may include a substantially electrically conductive material around the first opening 311a and the second opening 311b. For example, when the communication circuit is connected to a first position (e.g., the coupling boss(es) 311c) adjacent to the first opening 311a and the second opening 311b, the circumference of the first opening 311a and/or the circumference of the second opening 311b of the first supporting members 411 may function as an antenna.

According to an embodiment, it may be understood that the first position, e.g., the coupling boss 311c, is aligned substantially side by side with a portion of the first opening 311a in a direction crossing the first direction D1. In an embodiment, it may be understood that the coupling boss 311c is aligned substantially side by side with a portion of the second opening 311b in the direction crossing the first direction D1. Here, the ‘direction crossing the first direction D1’ may be understood as including a second direction D2 substantially perpendicular to the first direction D1, and in an embodiment, may refer to a direction inclined by a designated angle rather than perpendicular (or parallel) to the first direction D1. In an embodiment, when the circumferential portions of the opening 311a, 311b, and 419 are to be implemented as radiating conductors, the position of the coupling boss 311c with respect to the first opening 311a and/or the position of the coupling boss 311c with respect to the second opening 311b may be appropriately selected according to the size of the openings 311a, 311b, and 419 and the resonant frequency to be secured.

According to an embodiment, when the coupling boss 311c is disposed adjacent to one end of the dividing bar 413, the first supporting member 411 may further include a second coupling boss 411c disposed at a second position adjacent to the other end of the dividing bar 413. In an embodiment, similar to how the coupling boss 311c is electromagnetically connected to the communication circuit, the second coupling boss 411c may be electromagnetically connected to the communication circuit. In an embodiment, an additional pad disposed adjacent to the second coupling boss 411c inside the printed circuit board 340 electrically connected to the communication circuit may be implemented similar to the feeding pad 341a, 341b of FIG. 7, and the additional pad corresponding to the second coupling boss 411c is described in more detail with reference to FIGS. 11 to 14.

According to an embodiment, the first opening 311a may be disposed at a first distance L1 from the second frame 410b, the second opening 311b may be disposed at a second distance L2 from the second frame 410b, and/or the coupling boss 311c may be disposed at a third distance L3 from the second frame 410b. Here, the first distance L1, the second distance L2, and/or the third distance L3 may be defined as a distance measured along the first direction D1 from the outer surface of the second frame 410b. In an embodiment, the first distance L1, the second distance L2, and/or the third distance L3 may be defined as a distance measured along the first direction D1 from the inner surface of the second frame 410b. In an embodiment, when defined as the distance from the inner surface of the second frame 410b, the distance between the first opening 311a and the second frame 410b may be understood as zero, but may vary according to the position of the first opening 311a. For example, it may be understood that the second frame 410b defines a portion of the first opening 311a.

According to an embodiment, the third distance L3 may be larger than the first distance L1 and smaller than the second distance L2. In an embodiment, the third distance L3 may be larger than the width of the first opening 311a or the length of the first opening 311a. In an embodiment, when the third distance L3 is smaller than the second distance L2 and larger than the width (or length) of the first opening 311a, it may be understood that the coupling boss 311c is disposed adjacent to one end of the dividing bar 413. In an embodiment, the coupling boss 311c may partially overlap the first opening 311a or partially overlap the second opening 311b in the second direction D2 perpendicular to the first direction D1. For example, when viewed in the plan view illustrated in FIG. 10, the diameter of the coupling boss 311c may be variously implemented. In an embodiment, in implementing a stable electrical connection (electromagnetic coupling or direct contact) with a printed circuit board (e.g., feeding pad(s) 341a, 341b) (s), the diameter of the coupling boss 311c may be appropriately selected.

FIG. 11 is a view illustrating an antenna structure 597a implemented in an electronic device (e.g., the electronic device 1001, 1002, 1004, 100, 200, or 300 of FIGS. 1 to 6) according to an embodiment of the disclosure.

Referring to FIG. 11, the dividing bar 413 may be substantially a portion of the first supporting member 411, and may extend in a direction crossing the first direction D1 to be disposed between the first opening 311a and the second opening 311b. In an embodiment, the coupling boss (e.g., the coupling boss 311c of FIGS. 6, 7 and/or 10) and/or the feeding pad 541 (e.g., the feeding pad(s) 341a, 341b of FIG. 7 or 8) may be disposed adjacent to one of two opposite ends of the dividing bar 413. In an embodiment, the second coupling boss (e.g., the second coupling boss 411c of FIG. 10) may be disposed adjacent to the other end of the two opposite ends of the dividing bar 413. The configuration of the second coupling boss 411c may be similar to that of the coupling boss 311c of FIG. 7, but may differ in position from the coupling boss 311c of FIG. 7. In the illustrated embodiment, the dividing bar 413 may include a first dividing portion 413a adjacent to the coupling boss 311c (or the feeding pad 541), a second dividing portion 413b adjacent to the second coupling boss 411c (or the additional pad 543), and a connecting portion 413c mechanically connecting the first dividing portion 413a and the second dividing portion 413b. In an embodiment, the connecting portion 413c may include a polymer material to function as an insulating portion that mechanically connects the first dividing portion 413a and the second dividing portion 413b but electrically insulates them. In an embodiment, the connecting portion 413c may be substantially formed of an electrically conductive material.

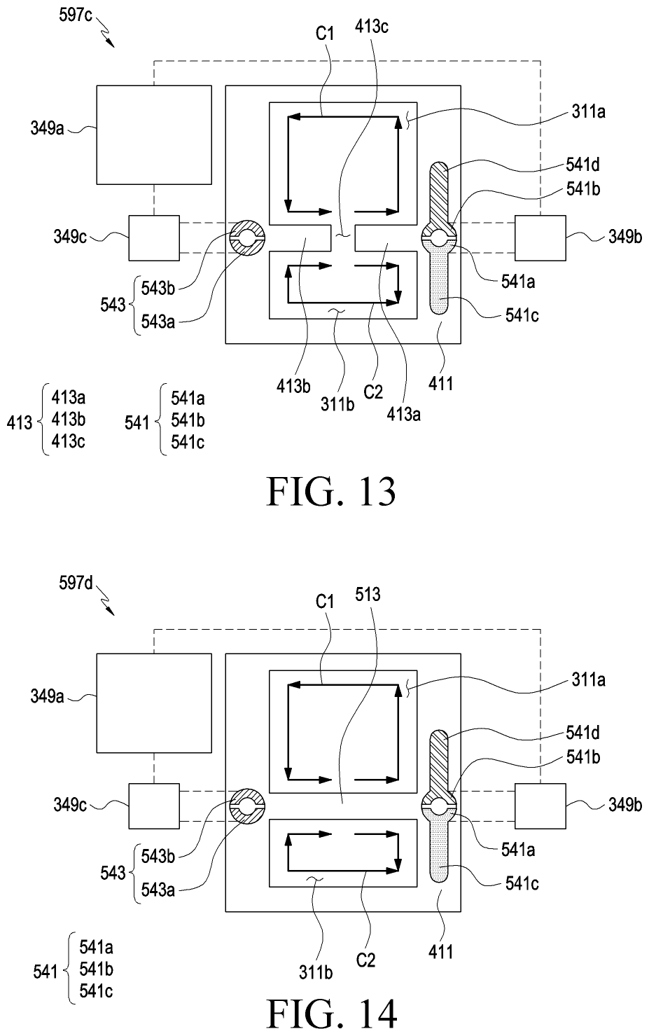

According to an embodiment, it may be understood that the dividing bar 413 extends in a direction crossing the first direction D1 between the coupling boss 311c and the second coupling boss 411c. In an embodiment, the second coupling boss 411c may be electrically connected to the printed circuit board 340 by including an electrically conductive material. Although not shown, in electrically connecting to the second coupling boss 411c, the printed circuit board 340 may include an additional pad(s) 543 and/or an additional fill-cut area corresponding to the second coupling boss 411c. The additional pad 543 and/or the additional fill-cut area for connection with the second coupling boss 411c may be similar to the feeding pad(s) 341a, 341b and/or the fill-cut area 343a of FIG. 7. In an embodiment, the additional pad 543 may be understood as a ground pad(s) electrically connected to the ground conductor of the printed circuit board 340. Referring to FIG. 13, the additional pad 543 may be electrically connected to a communication circuit (e.g., the integrated circuit chip 349a of FIG. 7), and in this case, it may be understood that the additional pad 543 is a feeding pad(s) independent of the feeding pad(s) 341a, 341b of FIG. 7. In an embodiment, the coupling boss 311c (e.g., the feeding pad 541) and the second coupling boss 411c (e.g., the additional pad 543) may be disposed in a designated distance from the first opening 311a and/or the second opening 311b.

According to an embodiment, the printed circuit board 340 may include a single feeding pad 541 at a position corresponding to the coupling boss 311c. When an electrical signal (e.g., a wireless communication signal) is applied to the first supporting member 411 through the feeding pad 541, a current flow path C1, C2 may be generated on the first supporting member 411 around the first opening 311a and/or the second opening 311b to receive or radiate a wireless communication signal. In an embodiment, when the sizes of the first opening 311a and the second opening 311b are different from each other, wireless communication using the first supporting member 411 may be implemented in at least two frequency bands. For example, the aforementioned ‘first frequency band’ may be understood as referring to two different frequency bands. For example, when the coupling boss 311c and/or the feeding pad 541 is electrically connected to the communication circuit, the additional pad 543 may connect the second coupling boss 411c to the ground conductor of the printed circuit board 340. In this case, the additional pad 543 may be understood as a single ground pad.

FIG. 12 is a view illustrating an antenna structure 597b implemented in an electronic device (e.g., the electronic device 1001, 1002, 1004, 100, 200, or 300 of FIGS. 1 to 6) according to an embodiment of the disclosure.

Compared to the embodiment of FIG. 11, the antenna structure 597b of FIG. 12 may differ in structure in that it further includes a plurality of feeding pad 541a and 541b (e.g., the first feeding pad 541a and the second feeding pad 541b), and an extending portion(s) 541c, 541d. Accordingly, the components omitted in describing the antenna structure 597b of FIG. 12 may be easily understood with reference to the embodiment of FIG. 11. Referring to FIG. 12, when a plurality of feeding pad 541a and 541b are included, the antenna structure 597b may include a first switching element 349b (e.g., the first switching element 349b of FIG. 7 or 8) to select the feeding pad 541a, 541b to be connected to the communication circuit or at least one processor (e.g., the integrated circuit chip 349a) or to adjust the characteristics (or matching characteristics) of the transmission line from the communication circuit to the feeding pad(s) 541a, 541b.

According to an embodiment, the antenna structure 597b may include a plurality of (e.g., two) feeding pads 541a and 541b corresponding to one coupling boss (e.g., the second coupling boss 411c of FIG. 11). In an embodiment, it may be understood that the feeding pads 541a and 541b have a generally circular arc shape and are disposed along the circumferential direction. In an embodiment, it may be understood that the extending portions 541c and 541d extend from the feeding pads 541a and 541b, respectively, in parallel with the first opening 311a (or the second opening 311b). Although the feeding pad(s) 541a, 541b and the extending portion(s) 541c, 541d have been described separately for convenience of description, the extending portion(s) 541c, 541d may be understood to be substantially a portion of the feeding pad(s) 541a, 541b.

According to an embodiment, when the printed circuit board 340 is implemented as a multilayer circuit board, the extending portion(s) 541c, 541d may be disposed on the same layer as the first feeding pad 541a and/or the second feeding pad 541b. In an embodiment, when the printed circuit board 340 is implemented as a multilayer circuit board, the extending portion(s) 541c, 541d may be disposed on a different layer from the first feeding pad 541a and/or the second feeding pad 541b. In an embodiment, when disposed on a different layer, the extending portion(s) 541c, 541d may be electrically connected to the first feeding pad 541a and/or the second feeding pad 541b through a via conductor(s) that is not shown. Regardless of the layer on which the extending portion(s) 541c, 541d is disposed, the first feeding pad 541a and the second feeding pad 541b may be disposed on the same layer in the printed circuit board 340. The layer on which the first feeding pad 541a, the second feeding pad 541b, and/or the extending portion(s) 541c, 541d are disposed may be appropriately selected according to the specifications of the electronic device (e.g., the electronic device 1001, 1002, 1004, 100, 200, or 300 of FIGS. 1 to 6). For example, the first feeding pad 541a, the second feeding pad 541b, and/or the extending portion(s) 541c, 541d may be disposed on different layers in the printed circuit board 340.

FIG. 13 is a view illustrating an antenna structure 597c implemented in an electronic device (e.g., the electronic device 1001, 1002, 1004, 100, 200, or 300 of FIGS. 1 to 6) according to an embodiment of the disclosure.

Compared to the embodiment of FIG. 12, the antenna structure 597c of FIG. 13 may differ in structure that the additional pad 543 includes a third feeding pad 543a and a fourth feeding pad 543b and is electrically connected to a communication circuit (e.g., the integrated circuit chip 349a) through the second switching element 349c. Accordingly, the components omitted in describing the antenna structure 597c of FIG. 13 may be easily understood with reference to the embodiment of FIG. 12.

Referring to FIG. 13, the third feeding pad 543a and the fourth feeding pad 543b provided as the additional pad 543 may generally have an arc shape and be disposed along the circumferential direction. In an embodiment, the second switching element 349c may electrically connect the second coupling boss (e.g., the second coupling boss 411c of FIG. 10) corresponding to the third feeding pad 543a and the fourth feeding pad 543b and/or the additional pad 543 to the communication circuit or the processor. It should be noted that in an embodiment, the second switching element 349c may include a DPX, an MPX, an SPDT switch, or a DPDT switch, but is not limited thereto. In an embodiment, the electronic device 300 may select a pad to be connected to a communication circuit (or at least one processor) among the third feeding pad 543a and the fourth feeding pad 543b by including the second switching element 349c, or adjust the characteristics (or matching characteristics) of the transmission line from the communication circuit to the additional pad 543.

According to an embodiment, a resonant frequency in a different frequency band may be implemented according to a combination of the transmission line implemented by the first switching element 349b and the transmission line implemented by the second switching element 349c. For example, if the antenna structure 597a of FIG. 11 forms a resonant frequency in two bands, the antenna structure 597c of FIG. 13 may form a resonant frequency in three or more bands. However, with the position and size of the manufacturing specifications (e.g., the openings 311a and 311b), and the position of the coupling boss 311c (or the position of the second coupling boss 411c) with respect to the openings 311a and 311b already determined, the number of additional resonant frequencies may not be proportional to the number of added switching element(s).

FIG. 14 is a view illustrating an antenna structure 597d implemented in an electronic device (e.g., the electronic device 1001, 1002, 1004, 100, 200, or 300 of FIGS. 1 to 6) according to an embodiment of the disclosure.

Compared to the embodiment of FIG. 13, the antenna structure 597d of FIG. 14 may differ in that the dividing bar 513 is implemented by an electrically conductive material between the coupling boss 311c and the second coupling boss 411c, or between the feeding pad(s) 541 and the additional pad 543 without including an insulating structure. Accordingly, the components omitted in describing the antenna structure 597d of FIG. 14 may be easily understood with reference to the embodiment of FIG. 13.

Referring to FIG. 14, when the dividing bar 513 does not include an insulating structure, the first supporting member 411 may form a current flow path C1, C2 in a closed loop structure around the first opening 311a or the second opening 311b. For example, the first supporting member 411 may implement two loop antenna structures. In an embodiment, even if the first supporting member 411 provides the current flow path C1, C2 in the closed loop structure, the current flow path C1, C2 may be modified according to the structure of the feeding pad 541, the structure of the additional pad 543, and/or the operation state of the switching element 349b, 349c, and a resonant frequency may be secured in each different band by combining the operations of the switching elements 349b and 349c.

According to an embodiment, the antenna structure implemented around the openings 311a and 311b on the first supporting member 411 may have directivity. For example, the antenna structure may provide good wireless communication quality in a given direction and relatively low quality wireless communication performance in other directions. In an embodiment, even if the antenna structure provides excellent wireless communication quality in all directions, wireless communication quality in some directions may deteriorate depending on the actual deployed environment (e.g., due to interference with other components disposed around). For example, even with the same antenna structure, there may be deviations in communication quality depending on the characteristics (e.g., directivity) or disposition environment of the antenna structure itself. In an embodiment, it is possible to enhance the omnidirectional properties of the antenna structure while providing good wireless communication performance by varying the shape and arrangement of the feeding pads (e.g., the feeding pad(s) 341a, 341b of FIG. 7) considering the communication characteristics or arrangement environment of the antenna structure. The shape or disposition of the feeding pad(s) 341a, 341b is described with reference to FIGS. 15 to 19.

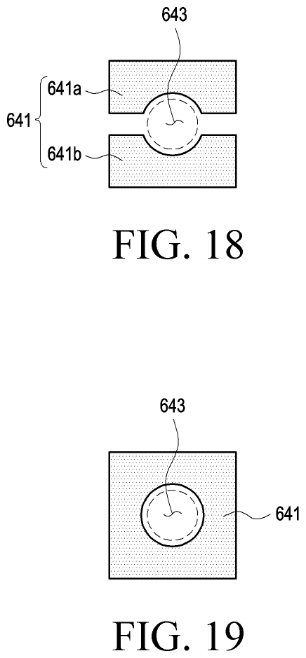

FIG. 15 is a view illustrating a shape or disposition of a feeding pad 641; 641a, 641b of an electronic device (e.g., the electronic device 1001, 1002, 1004, 100, 200, or 300 of FIGS. 1 to 6) according to an embodiment of the disclosure. FIG. 16 is a view illustrating a shape or disposition of a feeding pad 641; 641a, 641b of an electronic device (e.g., the electronic device 1001, 1002, 1004, 100, 200, or 300 of FIGS. 1 to 6) according to an embodiment of the disclosure. FIG. 17 is a view illustrating a shape or disposition of a feeding pad 641 of an electronic device (e.g., the electronic device 1001, 1002, 1004, 100, 200, or 300 of FIGS. 1 to 6) according to an embodiment of the disclosure. FIG. 18 is a view illustrating a shape or disposition of a feeding pad 641; 641a, 641b of an electronic device (e.g., the electronic device 1001, 1002, 1004, 100, 200, or 300 of FIGS. 1 to 6) according to an embodiment of the disclosure. FIG. 19 is a view illustrating a shape or disposition of a feeding pad 641 of an electronic device (e.g., the electronic device 1001, 1002, 1004, 100, 200, or 300 of FIGS. 1 to 6) according to an embodiment of the disclosure.

Referring to FIGS. 15 to 19, the feeding pad(s) 641; 641a, 641b has a generally circular or polygonal shape, and may be disposed at a position spaced apart from the fastening hole 643 (e.g., the fastening hole 343b of FIG. 7) by a designated interval. For example, although not assigned a reference numeral, the feeding pad(s) 641; 641a, 641b may provide an opening area with a size sufficient to accommodate the fastening hole 643 while being a circular or polygonal plate. In an embodiment, the feeding pad(s) 641; 641a, 641b may be implemented as a plurality of pads 641a and 641b are disposed around the fastening hole 643 as shown in FIGS. 15, 16, and/or 18, and may be disposed to substantially surround the fastening hole 643 while being a single pad as shown in FIGS. 17 and/or 19. For example, the number and shape of the feeding pad(s) 641; 641a, 641b disposed around one fastening hole 643 are not limited to the illustrated embodiment, and the antenna structure may be appropriately selected considering the specifications and inner structure of the device (e.g., the electronic device 1001, 1002, 1004, 100, 200, or 300 of FIGS. 1 to 6) where the antenna structure is to be actually disposed.

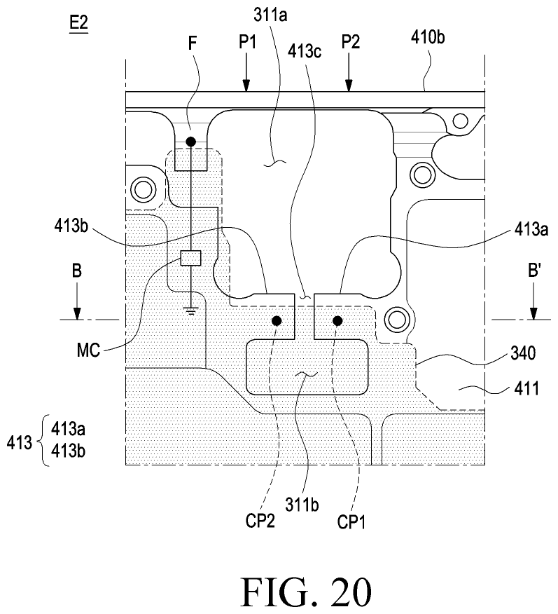

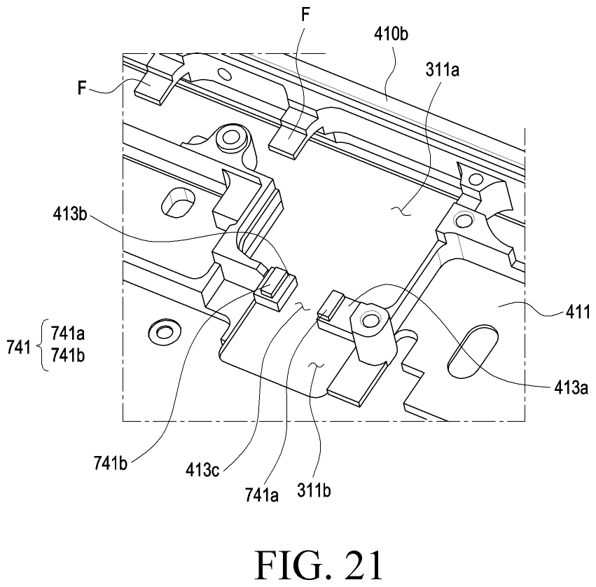

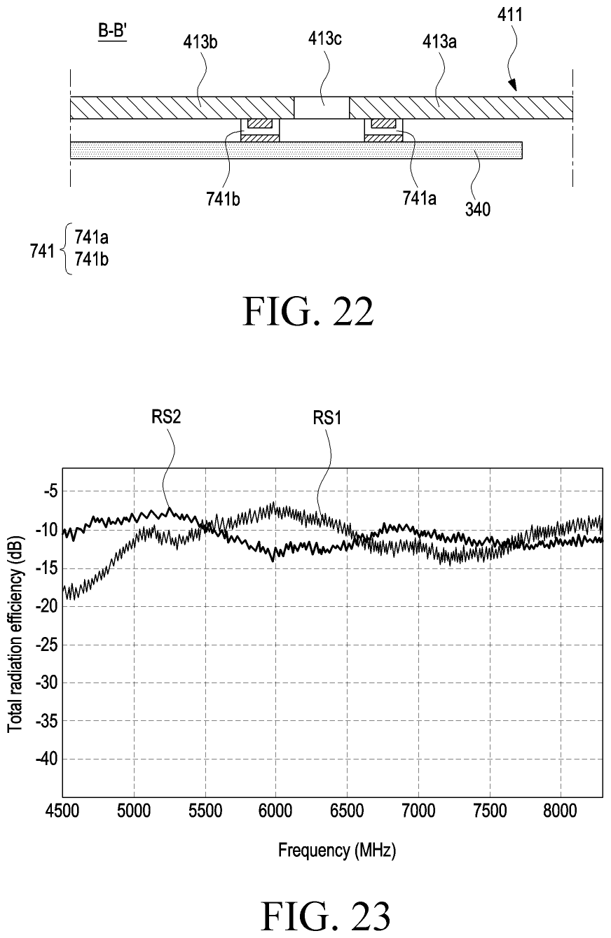

FIG. 20 is an enlarged view illustrating portion E2 of FIG. 9 of a first supporting member of an electronic device according to an embodiment of the disclosure. FIG. 21 is a view illustrating a connection state of a connecting member(s) of an electronic device according to an embodiment of the disclosure. FIG. 22 is a view illustrating a connection state of a connecting member(s) in an electronic device taken along line B-B′ of FIG. 20, according to an embodiment of the disclosure.

In describing an embodiment with reference to FIGS. 20 to 22, the same reference number may be assigned to the component similar to that of the preceding embodiment or the reference numeral may be omitted, and a detailed description thereof may also be omitted. At least some of the configurations of the embodiments described below may be selectively combined or replaced with the previous embodiments, implementing additional embodiments. For example, in the embodiment described below, one of the first contact member or the second contact member provided as a connecting member may be selectively combined with or replaced with the pad (e.g., the feeding pad 541 of FIG. 11 or the additional pad 543) of the previous embodiment to implement additional embodiments.

Referring to FIGS. 20 to 22, the electronic device (e.g., the electronic device 200 or 300 of FIGS. 4 to 7) may include a side structure (e.g., the side structure 410 or the second frame 410b of FIG. 9) and a first supporting member 411 (e.g., the first supporting member 311 of FIG. 6). In an embodiment, the side structure 410 and the first supporting member 411 of FIG. 20 may be substantially the same as the side structure 410 and/or the first supporting member 411 of FIG. 9. The first supporting member 411 may include, e.g., openings 311a and 311b (e.g., the first opening 311a and the second opening 311b of FIG. 6) provided to penetrate two opposite surfaces.

According to an embodiment, the printed circuit board 340 may be disposed on the first supporting member 411 in a space surrounded by the side structure 410. For example, a portion (e.g., a portion (e.g., the dividing bar 413) of the flange F and/or the first supporting member 411) of the side structure 410 may be disposed to at least partially overlap the printed circuit board 340. For example, the printed circuit board 340 may be understood to be disposed substantially in the space provided by the first supporting member 411 and/or the side structure 410. In an embodiment, when the first supporting member 411 and/or the side structure 410 at least partially includes an electrically conductive material, the printed circuit board 340 is electrically connected to the first supporting member 411 and/or the side structure 410, so that a portion of the first supporting member 411 and/or a portion (e.g., the second frame 410b) of the side structure 410 may function as an antenna. In an embodiment, when a portion of the first supporting member 411 is configured to perform wireless communication in a first frequency band, a portion of the side structure 410 may be configured to perform wireless communication in a second frequency band different from the first frequency band.

According to an embodiment, when a portion of the side structure 410 functions as an antenna for performing wireless communication, the communication circuit may be electrically connected to the side structure 410 through the flange F. For example, the communication circuit may be disposed or electrically connected to the printed circuit board 340. FIG. 20 illustrates that in an embodiment, the flange F extending from the second frame 410b is disposed to partially overlap the printed circuit board 340, and the printed circuit board 340 and the second frame 410b may be electrically connected in the overlapping portion. Although not shown, in electrically connecting the printed circuit board 340 and the second frame 410b, the electronic device 300 may include at least one connecting member disposed on the printed circuit board 340. The connecting member(s) may include, e.g., a contact member (e.g., an elastic member such as a C-clip) or the above-described electrically conductive pad (e.g., the feeding pad 541 of FIG. 11).

According to an embodiment, when a portion of the first supporting member 411 functions as an antenna for performing wireless communication, the printed circuit board 340 and/or the communication circuit may be electrically connected to the first supporting member 411 in an area between the first opening 311a and the second opening 311b. For example, when the communication circuit is electrically connected to the first supporting member 411 in the area between the first opening 311a and the second opening 311b, at least a portion of the circumferential area of the first opening 311a and/or the second opening 311b of the first supporting member 411 may function as an antenna for performing wireless communication. In the embodiments of FIGS. 20 to 22, the communication circuit may be electrically connected to the first supporting member 411 through the dividing bar 413 (e.g., the dividing bar 413 of FIG. 10). The dividing bar (e.g., the first dividing portion 413a and the second dividing portion 413b) is, e.g., a portion of the first supporting member 411 and is a structure disposed between the first opening 311a and the second opening 311b, and may be understood as defining a portion of the edge of the first opening 311a or the second opening 311b. In an embodiment, when the dividing bar 413 includes a first dividing portion 413a and a second dividing portion 413b that are mechanically connected to each other by an insulating portion (e.g., the connecting portion 413c) and are electrically insulated from each other, the printed circuit board 340 may be electrically connected to the first supporting member 411 through at least one of the first dividing portion 413a and the second dividing portion 413b.

According to an embodiment, when at least a portion of the circumferential area of the first opening 311a and/or the second opening 311b functions as an antenna for performing wireless communication, the first dividing portion 413a may be electrically connected to the communication circuit, and the second dividing portion 413b may be electrically connected to the ground. In an embodiment, in a structure in which the first dividing portion 413a is electrically connected to the communication circuit and the second dividing portion 413b is electrically connected to the ground, the flange F adjacent to the first opening may be electrically connected to a common ground with the second dividing portion 413b. For example, a loop antenna may be implemented in a circumferential area of the first opening 311a and/or the second opening 311b. In an embodiment, in electrically connecting the flange F to the ground, a matching circuit MC and/or a switching circuit may be disposed on the connection path. In an embodiment, the matching circuit MC and/or the switching circuit may be used to adjust or set the resonant frequency of the antenna secured in the circumferential area of the first opening 311a and/or the second opening 311b.

According to an embodiment, by disposing an additional slit (or additional segmentation structure similar to the dividing bar 413) in the edge of the first opening 311a and/or the second opening 311b or using the shape or size of the first opening 311a and/or the second opening 311b, the current distribution may be changed in the circumference of the first opening 311a and/or the second opening 311b, and an additional resonant frequency required in the design specifications or determining a frequency for wireless communication may be secured. In an embodiment, in a downsized electronic device, a resonant frequency of about 2 GHz or more may be secured when the circumferential area of the first opening 311a and/or the second opening 311b is implemented as an antenna. In an embodiment, when using the shape or size of the first opening 311a and/or the second opening 311b, when an additional slit is disposed in the edge of the first opening 311a and/or the second opening 311b, an additional resonant frequency may be obtained in a low frequency band in a range of about 600 MHz to about 1.5 GHZ.

According to an embodiment, the first opening 311a and/or the second opening 311b may be disposed to substantially overlap the display (e.g., the display 230 of FIG. 5). In an embodiment, at a position adjacent to the second frame 410b or the edge of the display 230, a portion of the first opening 311a may not overlap the display 230. For example, on the first opening 311a, a gap may be formed between the display 230 and the second frame 410b. When a portion of the first supporting member 411 functions as an antenna around the first opening 311a and/or the second opening 311b, a wireless signal may be radiated into the external space through the gap between the display 230 and the second frame 410b.

In the embodiments of FIGS. 20 to 22, the dividing bar 413 may include a first dividing portion 413a and a second dividing portion 413b, and a plurality of connecting members (e.g., the contact members 741; 741a, 741b) may be provided on the printed circuit board 340 to be electrically connected to the first supporting member 411. However, the embodiment(s) of the disclosure are not limited thereto, and one connecting member is provided on the printed circuit board 340 to be electrically connected to one of the first dividing portion 413a and the second dividing portion 413b, so that a portion (e.g., at least a portion of the circumferential area of the first opening 311a and the second opening 311b) of the first supporting member 411 may function as an antenna. In FIG. 20, points indicated by ‘CP1’ and ‘CP2’ may be understood as points where the connecting member is disposed or points in contact with the connecting member. In an embodiment, a resonant frequency secured in the circumferential area of the first opening 311a and the second opening 311b may be set according to the position of the connecting member(s), the length of the first dividing portion 413a and/or the second dividing portion 413b, and the size or relative position of the first opening 311a and/or the second opening 311b. For example, the connecting member(s) may function as a feeding terminal that applies an electrical signal (e.g., wireless communication signal) to the first supporting member 411, and at least a portion of the circumferential area of the first opening 311a and the second opening 311b may function as a radiating conductor. It may be understood that the ‘circumferential area of the first opening 311a and the second opening 311b’ mentioned in the embodiment(s) of the disclosure includes the first dividing portion 413a and/or the second dividing portion 413b.

Referring to FIG. 21, it may be understood that the connecting member(s) (e.g., the contact members 741) are disposed on the first supporting member 411 (e.g., the first dividing portion 413a and/or the second dividing portion 413b). However, the embodiments of the disclosure are not limited thereto, and the connecting member(s) may be substantially one of the electrical components disposed on the printed circuit board 340. For example, FIG. 21 may omit the printed circuit board 340 to illustrate the arrangement structure of the connecting member(s). In an embodiment, the connecting member(s) may be an elastic member formed of an electrically conductive material. For example, the connecting member(s) may be implemented as a leaf spring structure by bending a flat plate formed of a metal material. When the printed circuit board 340 is disposed on the first supporting member 411 and/or the dividing bar 413, the gap between the printed circuit board 340 and the first dividing portion 413a (or the second dividing portion 413b) may be smaller than the height of the connecting member(s) (e.g., the contact members 741).

According to an embodiment, when the printed circuit board 340 is assembled on the first supporting member 411 in a state in which the contact member(s) 741 are disposed, the contact member(s) 741 may accumulate elastic force while being lowered to a height corresponding to the gap between the printed circuit board 340 and the first dividing portion 413a (or the second dividing portion 413b). In an embodiment, the elastic force accumulated in the contact member(s) 741 may stably maintain a state in which a portion of the contact member(s) 741 is supported by the printed circuit board 340 and another portion contacts the first dividing portion 413a (or the second dividing portion 413b). For example, the contact member(s) 741 may be disposed on the printed circuit board 340 to be electrically connected to the first dividing portion 413a or the second dividing portion 413b. Although described with reference to FIGS. 24 to 26, the connecting member(s) may be implemented by an electrically conductive pad (e.g., the electrically conductive pad(s) 841a; 841b of FIGS. 24 to 26) configured to form electromagnetic coupling without directly contacting the dividing bar 413. For example, it should be noted that the structure in which the connecting member(s) directly contacts the dividing bar 413 does not limit the embodiment(s) of the disclosure. In describing the embodiment(s) of the disclosure, among the implementations of the connecting member(s), a component in direct contact with the dividing bar 413 may be referred to as a ‘contact member’.

According to an embodiment, when a plurality of connecting members are provided, the first contact member 741a among the connecting members may be disposed corresponding to the first dividing portion 413a, and the second contact member 741b may be disposed corresponding to the second dividing portion 413b. In an embodiment, the first contact member 741a may function as a feeding terminal for supplying power or providing a wireless communication signal. In an embodiment, when the first contact member 741a functions as a feeding terminal, the second contact member 741b may be understood as being provided for grounding. For example, the second contact member 741b may be electrically connected to a ground conductor (e.g., the ground conductor GC of FIG. 24) provided inside the printed circuit board 340. In an embodiment, the second contact member 741b may be provided as a feeding terminal, and the first contact member 741a may be provided as a ground terminal. As mentioned above, one connecting member (e.g., any one of the first contact member 741a and the second contact member 741b) may be provided on the printed circuit board 340 to be electrically connected to a corresponding one of the first dividing portion 413a and the second dividing portion 413b. Considering the structure or resonant frequency of the antenna to be implemented in the circumferential area of the first opening 311a and/or the second opening 311b, the number and positions of connecting members may be appropriately selected.

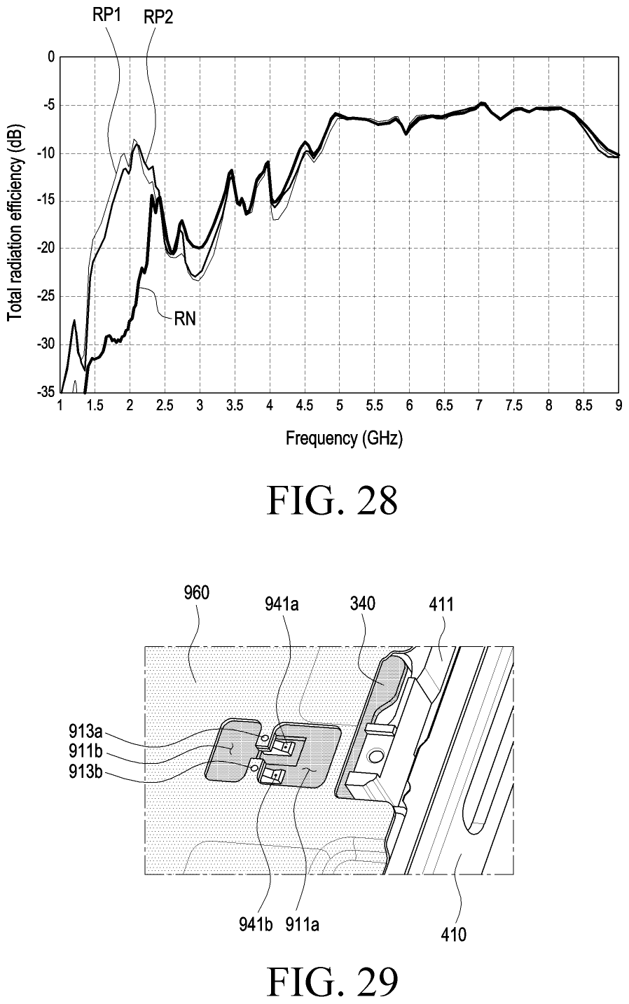

According to an embodiment, when an insulating structure is added to the first supporting member 411 and/or the side structure 410 in a structure in which at least a portion of the circumferential area of the first opening 311a and/or the second opening 311b is implemented as an antenna, a resonant frequency may be additionally secured or the implemented resonant frequency may be adjusted. In an embodiment, the side structure 410 (e.g., the second frame 410b) may be understood as a structure surrounding a portion of the first opening 311a. In FIG. 20, the point indicated by ‘P1’ or ‘P2’ may be implemented as an insulating portion (e.g., the connecting portion 413c of FIG. 11). In an embodiment, a path that bypasses the first opening 311a from the first dividing portion 413a and sequentially passes through the point P2 and the point P1 may function as a structure that determines an electrical length of a radiating conductor (e.g., a portion of the first supporting member 411). For example, when the insulating structure similar to the connecting portion 413c is provided at either the point P2 or the point P1, the electronic device 300 may adjust the resonant frequency of the antenna implemented in the circumferential area of the first opening 311a or secure an additional resonant frequency. A configuration in which an additional resonant frequency is secured is described again with reference to FIG. 28.

FIG. 23 is a graph illustrating the performance of an antenna implemented in an electronic device according to an embodiment of the disclosure.

Referring to FIG. 23, the graph indicated by ‘RS1’ may illustrate a result of measuring radiation efficiency in the range of about 4.5 to 8.0 GHz when any one of the first frame 410a, the second frame 410b, and/or the third frame 410c is implemented as an antenna. In FIG. 23, the graph indicated by ‘RS2’ may illustrate the result of measuring radiation efficiency in the range of about 4.5 to 8.0 GHz when implementing an antenna for wireless communication using a portion (e.g., at least a portion of the circumferential area of the first opening 311a and/or the second opening 311b) of the first supporting member 411. In general, when an antenna (e.g., a radiating conductor) is disposed at the edge of the electronic device 300 or is substantially exposed to external space, wireless communication performance may be expected to be better secured. As illustrated in FIG. 23, although there is some deviation depending on the frequency band, the antenna of the embodiment(s) of the disclosure (e.g., the antenna implemented in the circumferential area of the opening(s) 311a, 311b provided in the first supporting member 411) may provide wireless communication performance similar to that of the antenna implemented by a portion of the side structure 410. For example, the embodiment(s) of the disclosure may provide an enhanced degree of freedom in design in implementing the wireless communication function of the downsized electronic device.

According to an embodiment, when the printed circuit board 340 and the supporting member (e.g., the first supporting member 411 of FIG. 21) are electrically connected, unlike the contact member(s) 741 of FIG. 21, an electrically conductive pad 841; 841a, 841b may be provided as the connecting member(s). For example, by forming an electromagnetic coupling between the printed circuit board 340 and the first supporting member 411, at least a portion of the circumferential area of the first opening 311a and/or the second opening 311b may function as a radiating conductor. In an embodiment, the portion of the first supporting member 411 forming the electromagnetic coupling may be an area between the first opening 311a and the second opening 311b. In an embodiment, an electromagnetic coupling may be formed between the first dividing portion 413a and the printed circuit board 340, and/or between the second dividing portion 413b and the printed circuit board 340. In an embodiment, the printed circuit board 340 may include at least one electrically conductive pad 841 to form an electromagnetic coupling with the first supporting member 411. A configuration in which at least a portion of the first supporting member 411 is implemented as an antenna using electromagnetic coupling is described with reference to FIGS. 24 to 26.

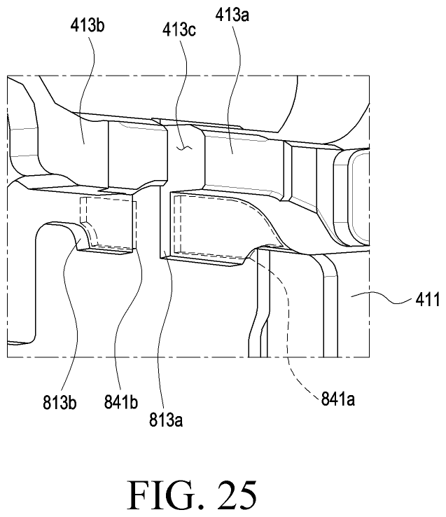

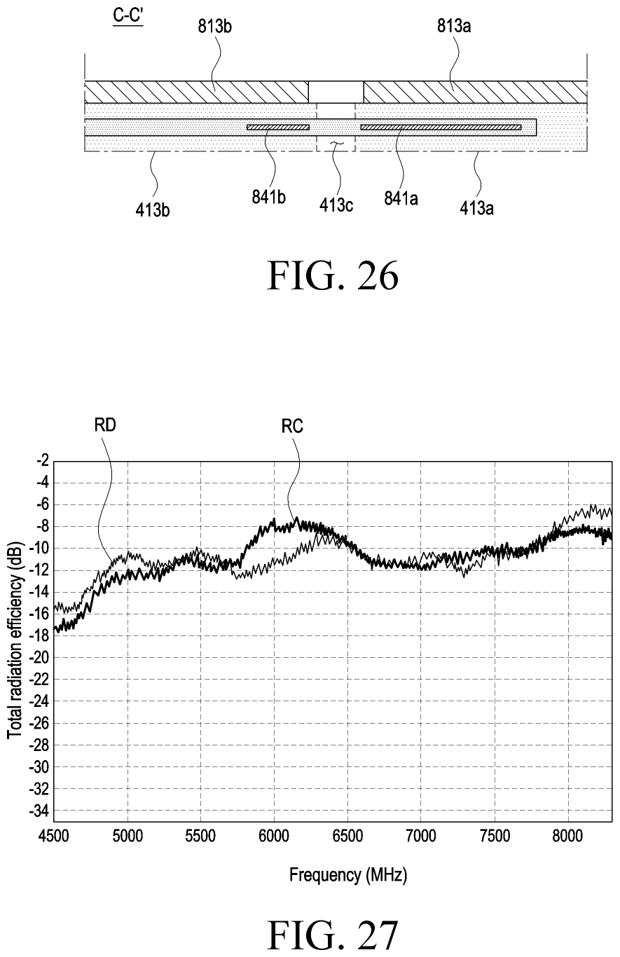

FIG. 24 is a view illustrating an implementation example of a connecting member(s) of an electronic device according to an embodiment of the disclosure. FIG. 25 is a view illustrating a connection state of a connecting member(s) of an electronic device according to an embodiment of the disclosure. FIG. 26 is a view illustrating a connection state of a connecting member(s) in an electronic device taken along line C-C′ of FIG. 24, according to an embodiment of the disclosure.

Referring to FIGS. 24 to 26, a printed circuit board 340 may include at least one electrically conductive pad 841; 841a, 841b. The electrically conductive pad (s 841 may be disposed on the printed circuit board 340, e.g., like the feeding pad 341a, 341b of FIG. 7. In an embodiment, the electrically conductive pad(s) 841 may be disposed to face a corresponding one of the first dividing portion 413a and the second dividing portion 413b. For example, the electrically conductive pad(s) 841 may form an electromagnetic coupling with a corresponding one of the first dividing portion 413a and the second dividing portion 413b. Accordingly, the printed circuit board 340 and the first supporting member 411 may be electrically connected to each other by electromagnetic coupling.

According to an embodiment, when a plurality of electrically conductive pads 841 are provided, the first electrically conductive pad 841a may be disposed to face any one of the first dividing portion 413a and the second dividing portion 413b, and the second electrically conductive pad 841b may be disposed to face the other of the first dividing portion 413a and the second dividing portion 413b. However, the embodiment(s) of the disclosure are not limited thereto, and any one of the first electrically conductive pad 841a and the second electrically conductive pad 841b may be omitted considering the manufacturing specifications of the electronic device 300 or the specifications of the antenna to be implemented. In an embodiment, the first electrically conductive pad 841a may form electromagnetic coupling with the first dividing portion 413a to supply power (or feed signal), and the second electrically conductive pad 841b may form electromagnetic coupling with the second dividing portion 413b for grounding. In an embodiment, when used to supply power (or feed signal), the first electrically conductive pad 841a may be electrically connected to the wireless communication circuit WCC. In an embodiment, the second electrically conductive pad 841b may be understood as being electrically connected to a ground conductor GC (or a ground plane) provided on the printed circuit board 340.

According to an embodiment, the electrically conductive pad(s) 841; 841a, 841b may be disposed to substantially face a corresponding one of the first dividing portion 413a and/or the second dividing portion 413b. In an embodiment, in the printed circuit board 340, an area between the electrically conductive pad(s) 841 and the first dividing portion 413a (and/or the second dividing portion 413b) may be provided as a fill-cut area (e.g., the fill-cut area 343a of FIG. 7). For example, when the printed circuit board 340 is disposed on the first supporting member 411, no electrically conductive material may be substantially disposed in the area between the electrically conductive pad(s) 841 and the first dividing portion 413a (and/or the second dividing portion 413b).

According to an embodiment, in the structure for forming the electromagnetic coupling, the first supporting member 411, the first dividing portion 413a, and/or the second dividing portion 413b may further include an extending portion(s) 813a, 813b corresponding to the electrically conductive pad(s) 841. For example, it may be understood that the extending portion(s) 813a, 813b is a portion of the first dividing portion 413a and/or the second dividing portion 413b. In an embodiment, as the gap between two electrically conductive structures decreases, and/or the area in which the two electrically conductive structures face each other increases, the efficiency of the electromagnetic coupling may increase. For example, the electromagnetic coupling efficiency between the electrically conductive pad(s) 841; 841a, 841b and the first supporting member 411 may be increased by providing the extending portion(s) 813a, 813b.

According to an embodiment, the first supporting member 411 may be provided with a first extending portion 813a extending (or expanded) from the first dividing portion 413a and/or a second extending portion 813b extending (or expanded) from the second dividing portion 413b. In an embodiment, the first electrically conductive pad 841a may be disposed to substantially face the first extending portion 813a, and/or the second electrically conductive pad 841b may be disposed to substantially face the second extending portion 813b. For example, as an electromagnetic coupling is formed in the area between the first opening 311a and the second opening 311b, a feed signal may be provided to one side (e.g., the first dividing portion 413a) of the insulating portion (e.g., the connecting portion 413c of FIG. 25), and/or the ground conductor GC may be electrically connected to the other side (e.g., the second dividing portion 413b) of the insulating portion. In the illustrated embodiment, ‘electrical connection’ may be implemented by electromagnetic coupling.

FIG. 27 is a graph illustrating the performance of an antenna implemented in an electronic device according to a feeding scheme according to an embodiment of the disclosure.

Referring to FIG. 27, the graph indicated by ‘RD’ may indicate the total radiation efficiency when the printed circuit board 340 and the first supporting member 411 are electrically connected by the contact members 741, 741a, and 741b of FIG. 21 so that a portion of the first supporting member 411 is operated as an antenna, and the graph indicated by ‘RC’ may indicate the total radiation efficiency when the printed circuit board 340 and the first supporting member 411 are electrically connected by the electrically conductive pads 841; 841a, 841b of FIG. 25 so that a portion of the first supporting member 411 is operated as an antenna. For example, when a portion of the first supporting member 411 is implemented as an antenna, the radiation efficiency using the direct feeding structure of FIG. 21 and the radiation efficiency using the indirect feeding structure of FIG. 25 may be understood as illustrated in FIG. 27. As illustrated in FIG. 27, when the printed circuit board 340 and the first supporting member 411 are electrically connected in an area between the first opening 311a and the second opening 311b to implement a portion of the first supporting member 411 as an antenna, it may be identified that the radiation efficiency in the direct feeding structure and the radiation efficiency in the indirect feeding structures are similar.

According to an embodiment, when the antenna is implemented using at least a portion of the circumferential area of the first opening 311a and/or the second opening 311b, it may be easy to adjust the resonant frequency and/or secure an additional resonant frequency. For example, by adjusting the electrical length at which current or wireless signal power may be distributed in the circumferential area of the first opening 311a and/or the second opening 311b, the resonant frequency may be adjusted or additional resonant frequencies may be secured. This is described with reference to FIG. 28 together with FIG. 20.

FIG. 28 is a graph illustrating the performance and operation frequency band of an antenna implemented in an electronic device according to an embodiment of the disclosure.

In FIG. 28, the graph indicated by ‘RN’ may indicate the total radiation efficiency when a portion of the first supporting member 411 is implemented as an antenna, and no insulating structure is provided at the points P1 and P2 of the side structure 410 (e.g., the second frame 410b) of FIG. 20. In FIG. 28, the graph indicated by ‘RP1’ and/or ‘RP2’ may indicate the total radiation efficiency when a portion of the first supporting member 411 is implemented as an antenna as in the above-described embodiment, but an insulating structure is provided at either the point P1 or the point P2 of the side structure 410 (e.g., the second frame 410b) of FIG. 20. Provides an insulating structure at either the point P1 or P2′ may be substantially identical or similar to a structure of providing the connecting portion 413c to mechanically connect the first dividing portion 413a and the second dividing portion 413b but electrically insulate them in implementing the dividing portion 413 of FIG. 11.

Referring to FIG. 28, it may be identified that an antenna without an insulating structure provides a radiation efficiency of about −10 dB or more in a frequency band of about 4.5 GHz or more. In an embodiment, when a portion of the first supporting member 411 is implemented as an antenna and the insulating structure is disposed at either the point P1 or the point P2 of the side structure (e.g., the second frame) of FIG. 20, it may be identified that a radiation efficiency of about −10 dB or more is additionally provided in a frequency band of about 2 GHz. For example, it is possible to secure an additional resonant frequency or adjust the resonant frequency of the antenna while implementing at least a portion of the circumferential area of the first opening as an antenna through the disposition of the insulating structure disposed on a portion of the structure defining the circumferential area of the first opening 311a. Although not illustrated, a slit extending from the edge of the first opening 311a and/or the edge of the second opening 311b of FIG. 20 to the inside of the first supporting member 411 may be added to adjust the resonant frequency or secure an additional resonant frequency. In an embodiment, when adjusting the resonant frequency or securing an additional resonant frequency, the size or shape of the first opening 311a and/or the second opening 311b of FIG. 20 may be changed.

According to an embodiment, in a flat plate structure disposed in the electronic device 300, and/or when the flat plate structure includes an opening(s), at least a portion of the flat plate structure may be implemented as an antenna. A structure in which the flat plate structure inside the electronic device 300 is implemented as an antenna is described with reference to FIG. 29.

FIG. 29 is a view illustrating an implementation example of an antenna using a second supporting member in an electronic device according to an embodiment of the disclosure.

Referring to FIG. 29, a second supporting member 960 (e.g., the second supporting member 260 of FIG. 4 or 6) disposed to face a first supporting member (e.g., the first supporting member 411 of FIG. 20) with the printed circuit board 340 interposed therebetween may be disposed inside the electronic device 300. The second supporting member 960 may function as one of the support plates inside the electronic device 300, for example. In an embodiment, the second supporting member 690 may include a third opening 911a and/or a fourth opening 911b. For example, the second supporting member 960 may include a third opening 911a and a fourth opening 911b, similar to the first opening 311a and/or the second opening 311b of FIG. 20, and a third dividing portion 913a and a fourth dividing portion 914b may be provided in an area between the third opening 911a and the fourth opening 911b.

According to an embodiment, in implementing a portion of the second supporting member 960 as an antenna, the electronic device 300 and/or the printed circuit board 340 may include a third contact member 941a and a fourth contact member 941b. For example, the third contact member 941a may be configured to be in contact (or electrically connected) with the third dividing portion 913a, and the fourth contact member 941b may be configured to be in contact (or electrically connected) with the fourth dividing portion 913b. In an embodiment, since a portion of the second supporting member 960 is implemented as an antenna, the resonant frequency may be adjusted or an additional resonant frequency may be secured according to the shape or size of the third opening 911a and/or the fourth opening 911b.

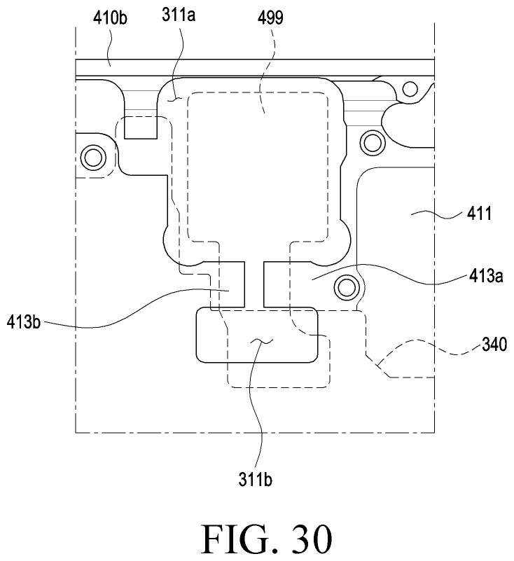

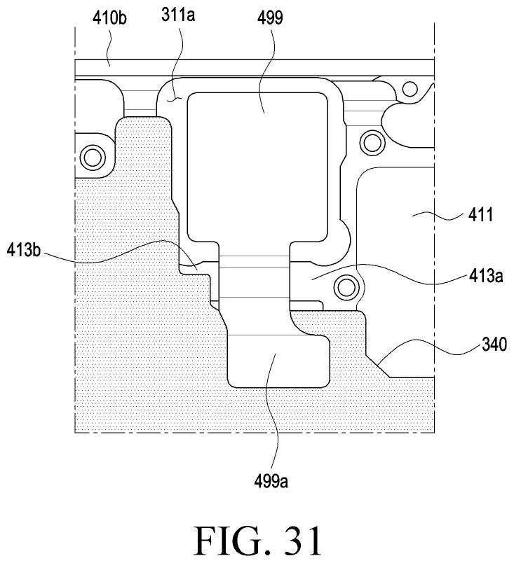

FIG. 30 is an enlarged view illustrating portion E2 of FIG. 9 of a first supporting member of an electronic device according to an embodiment of the disclosure. FIG. 31 is a view illustrating a state in which a printed circuit board and/or an electronic component is disposed on a first supporting member of an electronic device according to an embodiment of the disclosure.

Referring to FIGS. 30 and 31, an electronic device (e.g., the electronic device 300 of FIG. 6) may include an electronic component, e.g., the camera module 499, disposed in the first opening 311a. In an embodiment, the camera module 499 may be electrically connected to the printed circuit board 340 by including a dividing bar, e.g., a flexible printed circuit board 499a disposed across the first dividing portion 413a and/or the second dividing portion 413b. In an embodiment, when the flexible printed circuit board 499a is disposed to cross the first dividing portion 413a and/or the second dividing portion 413b, a contact member (e.g., the contact member 741; 741a, 741b of FIG. 12) or a pad (e.g., the electrically conductive pad 841; 841a, 841b of FIG. 26) (not shown) may be provided. For example, the flexible printed circuit board 499a may be electrically connected to the first dividing portion 413a and/or the second dividing portion 413b, or may form an electromagnetic coupling with the first dividing portion 413a and/or the second dividing portion 413b. In an embodiment, the printed circuit board 340 and/or the communication circuit may be electrically connected to the first dividing portion 413a and/or the second dividing portion 413b via the flexible printed circuit board 499a, thereby performing wireless communication using at least a portion of the first supporting member 411 around the first opening 311a and/or the second opening 311b.

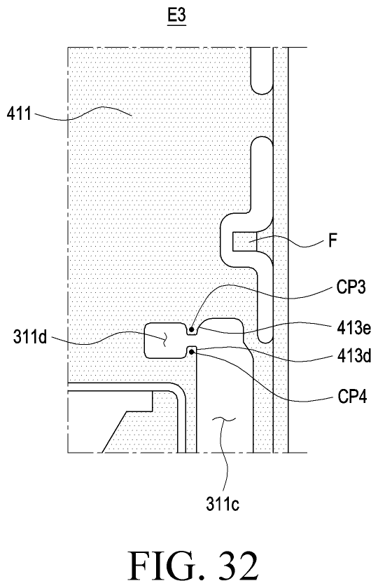

FIG. 32 is an enlarged view illustrating portion E3 of FIG. 9 of a first supporting member of an electronic device according to an embodiment of the disclosure.

Referring to FIG. 32, the electronic device 300 and/or the first supporting member 411 may include a third opening 311c and a fourth opening 311d disposed at different positions from the first opening 311a or the second opening 311b of the above-described embodiment. In an embodiment, regardless of the antenna being implemented around the first opening 311a or the second opening 311b, the electronic device 300 may include an antenna implemented by another portion of the first supporting member 411 around the third opening 311c and/or the fourth opening 311d. For example, a third dividing bar 413e and/or a fourth dividing bar 413d may be provided between the third opening 311c and the fourth opening 311d, and the third dividing bar 413e and/or the fourth dividing bar 413d may be electrically connected to a printed circuit board (e.g., the printed circuit board 340 of FIG. 22) or a communication circuit at at least one of the contact points CP3 and CP4. For example, any one of the contact points CP3 and CP4 may be understood as a feeding point. In an embodiment, when any one of the contact points CP3 and CP4 is used as a feeding point, the other of the contact points CP3 and CP4 may be used as a ground point. For example, any one of the contact points CP3 and CP4 may be electrically connected to the communication circuit, and the other of the contact points CP3 and CP4 may be electrically connected to the ground.

As described above, an electronic device according to an embodiment(s) of the disclosure may implement an antenna structure using an inner structure such as a supporting member. For example, by utilizing a structure for disposing various components, such as a printed circuit board, as a radiating conductor, it is possible to secure an additional resonant frequency while suppressing design changes in the inner structure. Effects of the disclosure are not limited to the foregoing, and other unmentioned effects would be apparent to one of ordinary skill in the art from the description of the foregoing embodiment(s).

According to an embodiment of the disclosure, an electronic device (e.g., the electronic device 1001, 1002, 1004, 100, 200, or 300 of FIGS. 1 to 6) may comprise a housing (e.g., the housing 201 of FIGS. 4 to 6) including a front plate (e.g., the front plate 220 of FIGS. 4 to 6) and a rear plate (e.g., the rear plate 280 of FIGS. 4 to 6) disposed opposite to the front plate, a support plate (e.g., the first supporting member 211, 311, or 411 of FIGS. 4, 5, 6, 7, 9, 10, and/or 20) disposed in a space between the front plate and the rear plate and including a first opening (e.g., the first opening 311a of FIGS. 6, 7, 9, 10, and/or 20) provided to penetrate the support plate, a second opening (e.g., the second opening 311b of FIGS. 6, 7, 9, 10, and/or 20) provided to penetrate the support plate at a position adjacent to the first opening and aligned with the first opening along a first direction (e.g., the first direction D1 of FIG. 9 or 10), a first dividing portion (e.g., the first dividing portion 413a of FIG. 20) and a second dividing portion (e.g., the second dividing portion 413b of FIG. 20) extending in an area between the first opening and the second opening, and an insulating portion (e.g., the connecting portion 413c of FIG. 20) configured to mechanically connect the first dividing portion and the second dividing portion and electrically insulate the first dividing portion and the second dividing portion, and a printed circuit board (e.g., the printed circuit board 240 or 340 of FIGS. 4 to 7 and/or 20) disposed on the support plate and electrically connected to the support plate in an area between the first opening and the second opening. In an embodiment, at least a portion of the support plate around the first opening or the second opening may be configured to function as an antenna and to perform wireless communication in a first frequency band.

According to an embodiment, the printed circuit board may be electrically connected to the support plate through at least one of the first dividing portion or the second dividing portion.

According to an embodiment, the printed circuit board may include at least one connecting member disposed on one surface thereof. According to an embodiment, the at least one connecting member may be electrically connected to at least one of the first dividing portion or the second dividing portion.

According to an embodiment, the printed circuit board may further comprise a first contact member (e.g., the first contact member 741a of FIG. 21) for power supply, which is disposed on one surface and electrically connected to one of the first dividing portion and the second dividing portion and a second contact member (e.g., the second contact member 741b of FIG. 21) for grounding, which is disposed on the one surface and electrically connected to the other of the first dividing portion and the second dividing portion.

According to an embodiment, the printed circuit board may further comprise at least one electrically conductive pad (e.g., the electrically conductive pad 841 of FIG. 25) disposed to face a corresponding one of the first dividing portion and the second dividing portion. In an embodiment, the at least one electrically conductive pad may be configured to form an electromagnetic coupling with the corresponding one of the first dividing portion and the second dividing portion.

According to an embodiment, the printed circuit board may comprise a first electrically conductive pad (e.g., the first electrically conductive pad 841a of FIG. 25) for power supply, configured to form an electromagnetic coupling with one of the first dividing portion and the second dividing portion and a second contact member (e.g., the second electrically conductive pad 841b of FIG. 25) for grounding, configured to form an electromagnetic coupling with the other of the first dividing portion and the second dividing portion.

According to an embodiment, the electronic device may further comprise a side structure (e.g., the side structure 210 or 410 of FIGS. 4 to 6, 9, and/or 10) configured to at least partially surround the space between the front plate and the rear plate, a radiating conductor (e.g., the second frame 410b of FIG. 20) that is a part of the side structure and electrically insulated from another part of the side structure, and a flange (e.g., the flange F of FIG. 20) protruding from an inner surface of the radiating conductor and electrically connected to the printed circuit board. In an embodiment, the radiating conductor may be configured to function as an additional antenna and to perform wireless communication in a second frequency band different from the first frequency band.

According to an embodiment, the radiating conductor may be configured to define or to surround a portion of the first opening.

According to an embodiment, the first opening may be disposed at a first distance (e.g., the first distance L1 of FIG. 10) from the radiating conductor along the first direction, and the second opening may be disposed at a second distance (e.g., the second distance L2 of FIG. 10) from the radiating conductor along the first direction. In an embodiment, the second distance may be greater than the first distance.

According to an embodiment, the electronic device may further comprise a camera module (e.g., the camera module 371 of FIG. 6) disposed in the first opening and a sensor module (e.g., the sensor module 373 of FIG. 6) disposed in the second opening.

According to an embodiment of the disclosure, an electronic device (e.g., the electronic device 1001, 1002, 1004, 100, 200, or 300 of FIGS. 1 to 6) may comprise a housing (e.g., the housing 201 of FIGS. 4 to 6) including a front plate (e.g., the front plate 220 of FIGS. 4 to 6) and a rear plate (e.g., the rear plate 280 of FIGS. 4 to 6) disposed opposite to the front plate, a support plate (e.g., the first supporting member 211, 311, or 411 of FIGS. 4, 5, 6, 7, 9, 10, and/or 20) disposed in a space between the front plate and the rear plate, a first opening (e.g., the first opening 311a of FIGS. 6, 7, 9, 10, and/or 20) provided to penetrate the support plate, a second opening (e.g., the second opening 311b of FIGS. 6, 7, 9, 10, and/or 20) provided to penetrate the support plate at a position adjacent to the first opening and aligned with the first opening along a first direction D1, a printed circuit board disposed on the support plate and electrically connected to the support plate in an area between the first opening and the second opening, at least one processor (e.g., the processor 1020 of FIG. 1), and memory (e.g., the memory 1030 of FIG. 1) storing instructions. In an embodiment, the instructions may, when executed by the at least one processor individually or collectively, cause the electronic device to perform wireless communication in a first frequency band using at least a portion of the support plate around the first opening or the second opening.

According to an embodiment, the support plate may further include a dividing bar (e.g., the dividing bar 413 of FIG. 10) extending in a direction crossing the first direction and disposed between the first opening and the second opening. In an embodiment, the printed circuit board may be electrically connected to the support plate through the dividing bar.

According to an embodiment, the printed circuit board may include at least one connecting member disposed on one surface thereof. In an embodiment, the at least one connecting member may be electrically connected to the dividing bar.

According to an embodiment, the dividing bar may comprise a first dividing portion (e.g., the first dividing portion 413a of FIG. 20) and a second dividing portion (e.g., the second dividing portion 413b of FIG. 20) extending in an area between the first opening and the second opening and an insulating portion (e.g., the connecting portion 413c of FIG. 20) configured to mechanically connect the first dividing portion and the second dividing portion but electrically insulate the first dividing portion and the second dividing portion.

According to an embodiment, the printed circuit board may further comprise a power supply contact member (e.g., the first contact member 741a of FIG. 21) disposed on one surface and electrically connected to one of the first dividing portion and the second dividing portion and a grounding contact member (e.g., the second contact member 741b of FIG. 21) disposed on the one surface and electrically connected to the other of the first dividing portion and the second dividing portion.

According to an embodiment, the printed circuit board may further comprise at least one electrically conductive pad (e.g., the electrically conductive pad 841 of FIG. 25) disposed to face a corresponding one of the first dividing portion and the second dividing portion. In an embodiment, the at least one electrically conductive pad may be configured to form an electromagnetic coupling with the corresponding one of the first dividing portion and the second dividing portion.

According to an embodiment, the electronic device may further comprise a side structure (e.g., the side structure 210 or 410 of FIGS. 4 to 6, 9, and/or 10) configured to at least partially surround the space between the front plate and the rear plate, a radiating conductor (e.g., the second frame 410b of FIG. 20) that is a part of the side structure and electrically insulated from another part of the side structure, and a flange (e.g., the flange F of FIG. 20) protruding from an inner surface of the radiating conductor and electrically connected to the printed circuit board. In an embodiment, the instructions may, when executed by the at least one processor individually or collectively, cause the electronic device to perform wireless communication in a second frequency band using the radiating conductor.

According to an embodiment, the radiating conductor may be configured to define or to surround a portion of the first opening.

According to an embodiment, the first opening may be disposed at a first distance (e.g., the first distance L1 of FIG. 10) from the radiating conductor along the first direction, and the second opening may be disposed at a second distance (e.g., the second distance L2 of FIG. 10) from the radiating conductor along the first direction. In an embodiment, the second distance may be greater than the first distance.

According to an embodiment, the electronic device may further comprise a camera module (e.g., the camera module 371 of FIG. 6) disposed in the first opening and a sensor module (e.g., the sensor module 373 of FIG. 6) disposed in the second opening.

According to an embodiment, an electronic device (e.g., the electronic device 1001, 1002, 1004, 100, 200, or 300 of FIGS. 1 to 6) may comprise a first supporting member (e.g., the first supporting member 211, 311, or 411 of FIGS. 4, 5, 6, 7, 9, and/or 10) including a coupling boss (e.g., the coupling boss 311c of FIGS. 6, 7, 9, and/or 10) provided on one surface thereof, a first opening (e.g., the first opening 311a of FIGS. 6, 7, 9, and/or 10) provided to penetrate the first supporting member at a position adjacent to the coupling boss, a second opening (e.g., the second opening 311b of FIGS. 6, 7, 9, and/or 10) provided to penetrate the first supporting member at a position adjacent to at least the first opening of the coupling boss and the first opening and aligned with the first opening along a first direction (e.g., the first direction D1 of FIG. 9 or 10), a printed circuit board (e.g., the printed circuit board 240 or 340 of FIGS. 4 to 7) supported by the coupling boss, disposed on the first supporting member, and electrically connected to the first supporting member through the coupling boss, at least one processor (e.g., the processor 1020 of FIG. 1), and memory (e.g., the memory 1030 of FIG. 1) storing instructions. In an embodiment, the instructions may, when executed by the at least one processor individually or collectively, cause the electronic device to perform wireless communication in a first frequency band using at least a portion of the first supporting member around the first opening or the second opening.

According to an embodiment, the printed circuit board may include at least one feeding pad provided therein to form an electromagnetic coupling with the coupling boss and/or the first supporting member. For example, when at least a portion of the first supporting member performs wireless communication around the first opening and/or the second opening, at least one feeding pad and/or coupling boss may function as a path or structure through which wireless communication signals are transferred. In an embodiment, the printed circuit board may be bound to the coupling boss by a fastening member such as a screw. The fastening member penetrating the printed circuit board and fastened to the coupling boss may be electrically insulated from, e.g., at least one feeding pad.

According to an embodiment, when the printed circuit board is a multi-layered circuit board, at least one feeding pad may be provided as an inner layer of the printed circuit board. In an embodiment, when the printed circuit board is disposed on the first supporting member, at least one feeding pad may be aligned at a position facing the coupling boss. In an embodiment, in a state in which at least one feeding pad is aligned at a position facing the coupling boss, the area between at least one feeding pad of the printed circuit board and the coupling boss may be implemented as a fill-cut area with the conductive material substantially removed.

According to an embodiment, an electronic device (e.g., the electronic device 1001, 1002, 1004, 100, 200, or 300 of FIGS. 1 to 6) may comprise a housing (e.g., the housing 201 of FIGS. 4 to 6) including a front plate (e.g., the front plate 220 of FIGS. 4 to 6) and a rear plate (e.g., the rear plate 280 of FIGS. 4 to 6) disposed opposite to the front plate, a first supporting member (e.g., the first supporting member 211, 311, or 411 of FIGS. 4, 5, 6, 7, 9, and/or 10) disposed in a space between the front plate and the rear plate and including a coupling boss (e.g., the coupling boss 311c of FIGS. 6, 7, 9, and/or 10) provided on one surface thereof, a first opening (e.g., the first opening 311a of FIGS. 6, 7, 9, and/or 10) provided to penetrate the first supporting member at a position adjacent to the coupling boss, a second opening (e.g., the second opening 311b of FIGS. 6, 7, 9, and/or 10) provided to penetrate the first supporting member at a position adjacent to at least the first opening of the coupling boss and the first opening and aligned with the first opening along a first direction (e.g., the first direction D1 of FIG. 9 or 10), a printed circuit board (e.g., the printed circuit board 240 or 340 of FIGS. 4 to 7) supported by the coupling boss, disposed on the first supporting member, and electrically connected to the first supporting member through the coupling boss, at least one processor (e.g., the processor 1020 of FIG. 1), and memory (e.g., the memory 1030 of FIG. 1) storing instructions. In an embodiment, the instructions may, when executed by the at least one processor individually or collectively, cause the electronic device to perform wireless communication in a first frequency band using at least a portion of the first supporting member around the first opening or the second opening.

According to an embodiment, the electronic device may further comprise a side structure (e.g., the side structure 210 or 410 of FIGS. 4 to 6, FIG. 9, and/or FIG. 10) configured to at least partially surround the space between the front plate and the rear plate, a radiating conductor (e.g., the second frame 410b of FIGS. 9 and/or 10) that is a part of the side structure and electrically insulated from another part of the side structure, and a flange (e.g., the flange F of FIG. 10) protruding from an inner surface of the radiating conductor and electrically connected to the printed circuit board. In an embodiment, the instructions may, when executed by the at least one processor individually or collectively, cause the electronic device to perform wireless communication in a second frequency band using the radiating conductor.

According to an embodiment, the radiating conductor may be configured to define or to surround a portion of the first opening.

According to an embodiment, the first opening may be disposed at a first distance (e.g., the first distance L1 of FIG. 10) from the radiating conductor along the first direction, and the second opening may be disposed at a second distance (e.g., the second distance L2 of FIG. 10) from the radiating conductor along the first direction. The coupling boss may be disposed at a third distance (e.g., the third distance L3 of FIG. 10) from the radiating conductor along the first direction. in an embodiment, the third distance may be larger than the first distance and smaller than the second distance.

According to an embodiment, the printed circuit board may include a fill-cut area (e.g., the fill-cut area 343a of FIG. 7) provided corresponding to the coupling boss, and at least one feeding pad (e.g., the feeding pad 341a or 341b of FIG. 7) provided in the fill-cut area and disposed to face or directly contact the coupling boss.

According to an embodiment, the at least one feeding pad may be electrically connected to a communication circuit (e.g., the communication module 1090 of FIG. 1 or the integrated circuit chip 349a of FIG. 7) or the at least one processor via a first switching element (e.g., the first switching element 349b of FIG. 7 or 8).

According to an embodiment, the at least one feeding pad may include an extending portion (e.g., the extending portion 541c or 541d of FIG. 12) disposed in parallel with the first opening or the second opening.

According to an embodiment, the printed circuit board may further include a fastening hole (e.g., the fastening hole 343b of FIG. 7) provided to penetrate the fill-cut area. In an embodiment, the at least one feeding pad may be disposed adjacent to the fastening hole.

According to an embodiment, the electronic device may further include a fastening member (e.g., the fastening member 359a of FIG. 7) configured to be fastened to the coupling boss through the fastening hole, and an insulating member (e.g., the insulating member 359b of FIG. 7) disposed between the inner wall of the fastening hole and the fastening member.

In an embodiment, the first supporting member may further include a dividing bar (e.g., the dividing bar 413 of FIG. 10) extending in a direction crossing the first direction and disposed between the first opening and the second opening. In an embodiment, the coupling boss may be disposed adjacent to one of two opposite ends of the dividing bar.

According to an embodiment, the first supporting member may further include a second coupling boss (e.g., the second coupling boss 411c of FIG. 10) disposed adjacent to the other end of the two opposite ends of the dividing bar on one surface and electrically connected to the printed circuit board.

According to an embodiment, the dividing bar may include a first dividing portion (e.g., the first dividing portion 413a of FIG. 11) disposed adjacent to the coupling boss, a second dividing portion (e.g., the second dividing portion 413b of FIG. 11) disposed adjacent to the second coupling boss, and an insulating portion (e.g., the connecting portion 413c of FIG. 11) mechanically connecting the first dividing portion and the second dividing portion but electrically insulating them.

According to an embodiment, the second coupling boss may be electrically connected to the communication circuit or the at least one processor via a second switching device (e.g., the second switching device 349c of FIG. 13).

According to an embodiment, the electronic device may further comprise a camera module (e.g., the camera module 371 of FIG. 6) disposed in the first opening and a sensor module (e.g., the sensor module 373 of FIG. 6) disposed in the second opening.

According to an embodiment, an electronic device (e.g., the electronic device 1001, 1002, 1004, 100, 200, or 300 of FIGS. 1 to 6) may comprise a housing (e.g., the housing 201 of FIGS. 4 to 6) including a front plate (e.g., the front plate 220 of FIGS. 4 to 6) and a rear plate (e.g., the rear plate 280 of FIGS. 4 to 6) disposed opposite to the front plate, a first supporting member (e.g., the first supporting member 211, 311, or 411 of FIGS. 4, 5, 6, 7, 9, and/or 10) disposed in a space between the front plate and the rear plate and including a coupling boss (e.g., the coupling boss 311c of FIGS. 6, 7, 9, and/or 10) provided on one surface thereof, a first opening (e.g., the first opening 311a of FIGS. 6, 7, 9, and/or 10) provided to penetrate the first supporting member at a position adjacent to the coupling boss, a second opening (e.g., the second opening 311b of FIGS. 6, 7, 9, and/or 10) provided to penetrate the first supporting member at a position adjacent to at least the first opening of the coupling boss and the first opening and aligned with the first opening along a first direction (e.g., the first direction D1 of FIG. 9 or 10), a printed circuit board (e.g., the printed circuit board 240 or 340 of FIGS. 4 to 7) supported by the coupling boss, disposed on the first supporting member, and electrically connected to the first supporting member through the coupling boss, at least one processor (e.g., the processor 1020 of FIG. 1), a side structure (e.g., the side structure 210 or 410 of FIGS. 4 to 6, 9, and/or 10) configured to at least partially surround a space between the front plate and the rear plate, a radiating conductor (e.g., the second frame 410b of FIGS. 9 and/or 10) being a portion of the side structure and electrically insulated from another portion of the side structure, and a flange (e.g., the flange F of FIGS. 9 and/or 10) protruding from an inner surface of the radiating conductor and electrically connected to the printed circuit board. In an embodiment, it may be configured to perform wireless communication in a first frequency band using at least a portion of the first supporting member and perform wireless communication in a second frequency band using the radiating conductor, around the first opening or the second opening.

According to an embodiment, the radiating conductor may be configured to define or to surround a portion of the first opening.

According to an embodiment, the printed circuit board may include a fill-cut area (e.g., the fill-cut area 343a of FIG. 7) provided corresponding to the coupling boss, and at least one feeding pad (e.g., the feeding pad 341a or 341b of FIG. 7) provided in the fill-cut area and disposed to face or directly contact the coupling boss.

According to an embodiment, the at least one feeding pad may be electrically connected to a communication circuit (e.g., the communication module 1090 of FIG. 1 or the integrated circuit chip 349a of FIG. 7) or at least one processor (e.g., the processor 1020 of FIG. 1) via a first switching element (e.g., the first switching element 349b of FIG. 7 or 8).

According to an embodiment, the electronic device may further include a fastening hole (e.g., the fastening hole 343b of FIG. 7) provided to penetrate the fill-cut area, a fastening member (e.g., the fastening member 359a of FIG. 7) configured to be fastened to the coupling boss through the fastening hole, and an insulating member (e.g., the insulating member 359b of FIG. 7) disposed between the inner wall of the fastening hole and the fastening member. In an embodiment, the at least one feeding pad may be disposed adjacent to the fastening hole.

According to an embodiment, the electronic device may further include a camera module 371 disposed in the first opening and a sensor module 373 disposed in the second opening.

In the above-described embodiment, the structure implemented in the first supporting member (e.g., the first supporting member 211 or 311 of FIG. 5 or 6) has been described but, when the second supporting member 260 (e.g., the upper supporting member 260a) of FIG. 4 or 5 includes an opening(s), at least a portion of the second supporting member may be implemented as an antenna or a radiating conductor. In the above-described embodiments, the values mentioned for the frequency band or radiation efficiency are exemplary, and the embodiment(s) of the disclosure are not limited thereto. The resonant frequency of the antenna implemented through the embodiment(s) of the disclosure and/or the radiation efficiency at the corresponding resonant frequency may be appropriately selected according to the specifications of the antenna and/or electronic device including the antenna to be actually manufactured.

While the disclosure has been described and shown in connection with an embodiment thereof, it should be appreciated that an embodiment is intended as limiting the disclosure but as illustrative. It will be apparent to one of ordinary skill in the art that various changes may be made in form and detail without departing from the overall scope of the disclosure, including the appended claims and their equivalents.

What is claimed is:

1. An electronic device, comprising:
a housing including a front plate and a rear plate disposed opposite to the front plate;
a support plate disposed in a space between the front plate and the rear plate and including:
a first opening provided to penetrate the support plate,
a second opening provided to penetrate the support plate at a position adjacent to the first opening and aligned with the first opening along a first direction,
a first dividing portion and a second dividing portion extending in an area between the first opening and the second opening, and
an insulating portion configured to mechanically connect the first dividing portion and the second dividing portion but electrically insulate the first dividing portion and the second dividing portion; and
a printed circuit board disposed on the support plate and electrically connected to the support plate in an area between the first opening and the second opening,
wherein at least a portion of the support plate around the first opening or the second opening is configured to function as an antenna and to perform wireless communication in a first frequency band.

2. The electronic device of claim 1, wherein the printed circuit board is electrically connected to the support plate through at least one of the first dividing portion or the second dividing portion.

3. The electronic device of claim 1,
wherein the printed circuit board includes at least one connecting member disposed on one surface thereof, and
wherein the at least one connecting member is electrically connected to at least one of the first dividing portion or the second dividing portion.

4. The electronic device of claim 1, wherein the printed circuit board further comprises:
a first contact member for power supply, which is disposed on one surface and electrically connected to one of the first dividing portion and the second dividing portion; and
a second contact member for grounding, which is disposed on the one surface and electrically connected to the other of the first dividing portion and the second dividing portion.

5. The electronic device of claim 1,
wherein the printed circuit board further comprises at least one electrically conductive pad disposed to face a corresponding one of the first dividing portion and the second dividing portion, and
wherein the at least one electrically conductive pad is configured to form an electromagnetic coupling with the corresponding one of the first dividing portion and the second dividing portion.

6. The electronic device of claim 1, wherein the printed circuit board further comprises:
a first electrically conductive pad for power supply, configured to form an electromagnetic coupling with one of the first dividing portion and the second dividing portion; and
a second electrically conductive pad for grounding, configured to form an electromagnetic coupling with the other of the first dividing portion and the second dividing portion.

7. The electronic device of claim 1, further comprising:
a side structure configured to at least partially surround the space between the front plate and the rear plate;
a radiating conductor that is a part of the side structure and electrically insulated from another part of the side structure; and
a flange protruding from an inner surface of the radiating conductor and electrically connected to the printed circuit board,
wherein the radiating conductor is configured to function as an additional antenna and to perform wireless communication in a second frequency band different from the first frequency band.

8. The electronic device of claim 7, wherein the radiating conductor is configured to define or to surround a portion of the first opening.

9. The electronic device of claim 7,
wherein the first opening is disposed at a first distance from the radiating conductor along the first direction,
wherein the second opening is disposed at a second distance from the radiating conductor along the first direction, and
wherein the second distance is greater than the first distance.

10. The electronic device of claim 1, further comprising:
a camera module disposed in the first opening; and
a sensor module disposed in the second opening.

11. An electronic device, comprising:
a housing including a front plate and a rear plate disposed opposite to the front plate;
a support plate disposed in a space between the front plate and the rear plate;
a first opening provided to penetrate the support plate;
a second opening provided to penetrate the support plate at a position adjacent to the first opening and aligned with the first opening along a first direction;
a printed circuit board disposed on the support plate and electrically connected to the support plate in an area between the first opening and the second opening;
at least one processor; and
memory storing instructions,
wherein the instructions, when executed by the at least one processor individually or collectively, cause the electronic device to perform wireless communication in a first frequency band using at least a portion of the support plate around the first opening or the second opening.

12. The electronic device of claim 11,
wherein the support plate further includes a dividing bar extending in a direction crossing the first direction and disposed between the first opening and the second opening, and
wherein the printed circuit board is electrically connected to the support plate through the dividing bar.

13. The electronic device of claim 12,
wherein the printed circuit board includes at least one connecting member disposed on one surface thereof, and
wherein the at least one connecting member is electrically connected to the dividing bar.

14. The electronic device of claim 12, wherein the dividing bar comprises:
a first dividing portion and a second dividing portion extending in an area between the first opening and the second opening; and
an insulating portion configured to mechanically connect the first dividing portion and the second dividing portion but electrically insulate the first dividing portion and the second dividing portion.

15. The electronic device of claim 14, wherein the printed circuit board further comprises:
a power supply contact member disposed on one surface and electrically connected to one of the first dividing portion and the second dividing portion; and
a grounding contact member disposed on the one surface and electrically connected to the other of the first dividing portion and the second dividing portion.

16. The electronic device of claim 14,
wherein the printed circuit board further comprises at least one electrically conductive pad disposed to face a corresponding one of the first dividing portion and the second dividing portion, and
wherein the at least one electrically conductive pad is configured to form an electromagnetic coupling with the corresponding one of the first dividing portion and the second dividing portion.

17. The electronic device of claim 11, further comprising:
a side structure configured to at least partially surround the space between the front plate and the rear plate;
a radiating conductor that is a part of the side structure and electrically insulated from another part of the side structure; and
a flange protruding from an inner surface of the radiating conductor and electrically connected to the printed circuit board,
wherein the instructions, when executed by the at least one processor individually or collectively, cause the electronic device to perform wireless communication in a second frequency band using the radiating conductor.

18. The electronic device of claim 17, wherein the radiating conductor is configured to define or to surround a portion of the first opening.

19. The electronic device of claim 17,
wherein the first opening is disposed at a first distance from the radiating conductor along the first direction,
wherein the second opening is disposed at a second distance from the radiating conductor along the first direction, and
wherein the second distance is greater than the first distance.

20. The electronic device of claim 11, further comprising:
a camera module disposed in the first opening; and
a sensor module disposed in the second opening.
